(19) United States
(12) Patent Application Publication
(10) Pub. No.: US 2015/0356664 A1
(43) Pub. Date: Dec. 10, 2015

(54) System And Method For Pre-ordering And Delivery Of Concession Products At Entertainment Venues

(71) Applicant: David Mackler, New York, NY (US)

(72) Inventor: David Mackler, New York, NY (US)

(21) Appl. No.: 14/732,265

(22) Filed: Jun. 5, 2015

Related U.S. Application Data
(60) Provisional application No. 62/008,369, filed on Jun. 5, 2014.

(51) Int. Cl. G06Q 30/06; G06Q 10/08

(52) U.S. Cl. CPC G06Q 30/0635; G06Q 10/0836

(57) ABSTRACT

A system and method for preordering and delivery of concession items is disclosed that enables users to pre-order food and other concessions either prior to arriving to a venue or in real time from the venue itself. The system allows for the installation of hardware having software loaded thereon for organizing fulfillment of orders and assigning storage locations and in some aspects, the system enables users to pick up orders from lockers or kiosks in a self service scenario.

### FIELD OF THE INVENTION

This invention relates generally to the food industry and the concession business within the entertainment and hospitality industries. More specifically, it relates a system and process for pre-ordering food and concessions via mobile phone applications and the internet and subsequently retrieving such orders at applicable venues.

### BACKGROUND OF THE INVENTION

Entertainment and hospitality venues, such as movie theaters, stadiums and hotels, focus on providing optimal customer experiences. These venues regularly generate lengthy lines and extended wait times for their food and beverage offerings. As consumers increasingly demand instant gratification—particularly in areas of commerce—these venues are tasked with offering innovative solutions to minimize, or completely eradicate, any delays or obstacles to obtaining the desired products in a timely manner. In order to maximize sales, and, as a result, profit per customer, it is necessary for sellers to not dissuade consumers from ordering due to perceived long waits or the possibility of missing their primary entertainment purpose be it a movie or sports game. To improve efficiency and, as a result, the customer experience, venues have sought to redesign traffic flow or improve the behind-the-counter delegation of labor; however, these initiatives are met with little overall effect. To this day, a customer attending a popular movie or event must still wait in line to place an order with a concessionaire, allow the payment to clear and wait while the order is prepared. In addition, merchants are always seeking to develop ways to minimize human error at the point-of-sale as well as the risk of theft. Finally, all companies are consistently trying to improve their operations such that they can better know their customers and reach them directly for residual sales opportunities. With all of this in mind, these industries are constantly seeking methods to shorten the lines to increase sales and improve the customer's experience, while customers are regularly opting for technological solutions to avoid wasting time. The invention and processes herein offers innovative methods and solutions to these problems.

### SUMMARY OF THE INVENTION

It is therefore an object of the present invention to provide a system that increases efficiency in the provision and distribution of concessions and reduces the wait time for consumers.

The systems and software processes disclosed herein enable customers to pre-order food and other concessions either prior to arriving to a venue or in real time from the venue itself. The system allows for the installation of hardware with software previously loaded thereon for implementing the tasks described herein. This system is linked to various mobile applications or websites through network connections, web servers and other computing devices to allow the consumer to pre-order concessions based on, for example, event location, schedule, seat assignment and others as more fully discussed herein.

In one embodiment, the user downloads the mobile application for his/her smartphone, accesses his/her account, and proceeds in the ordering process. Venues and/or events are selected and then the date that the user wants to order for is similarly selected. In the case of movies, for instance, the application allows the user to then choose the movie and applicable showtime prior to proceeding with the ordering from menu that may be customized for the particular theater. Similarly, in the case of a sports/concert venue, once the venue and date are selected, the event can be confirmed and a showtime may or may not be required prior to proceeding with the ordering from the menu. In this instance, the user may be provided with a code associated with their ticket that can be scanned, for example a QR code. In another embodiment, the user can simply enter their seat location when prompted. Based on the code scanned or information entered, the customer is directed to a particular concession stand within the entertainment venue that is closest to their seat. In other embodiments, scanning/entering the code and ordering of food allows for personnel at the venue to deliver the concession product directly to the seat associated with the ticket. Similarly, in the case of a hotel, if applicable, once selecting the hotel, the user may enter their room number and then choose between different menus based on the desired delivery time prior to proceeding with the ordering from a customized menu for that hotel.

Then, after confirming the order and selecting a pick-up time or delivery location, a confirmation code, such as a QR code is instantly generated for the user which is displayed in the app itself and, based on the user's preferences, emailed to the user as well.

In the movie example, the applicable order will be placed in the system queue for assembly in order to minimize wait times. For example larger orders may require additional assembly time and thus would be placed in the queue for assembly earlier than smaller orders. Prior to the user's designated pickup time, based on an algorithmic hierarchy, the applicable order appears on the venue's monitor to be fulfilled and held for the user. The user then, upon arriving at the venue, visits a designated area within the venue—whereby the QR code is scanned by the concessionaire and the respective order, which was previously fulfilled in anticipation of the user's arrival, is then delivered to user.

It is understood that the system described herein is not limited to movie theaters and QR codes and may include other means of identification including, but not limited to, unique codes, Bluetooth, and Near Field Communication, as other venues and other order identification and recognition systems can be used as would be apparent to one of skill in the art.

Therefore, in one aspect, a system is provided for delivery of pre-ordered concession items in a movie theater. The system includes a system computer in communication with a user computer via a network. In some embodiments, the system computer may be a tablet or smartphone, or may be a networked or cloud based computer/server. An order is received by the system computer via the network and is indicative of at least one concession item and a first time indicative of when a user submitting the order would like to pick up the order. An order fulfillment device installed at the applicable venue displays data indicative of the order and automatically determines a storage location for the order. An order identification reader associated with the system computer scans the corresponding QR code or other order identifier, reading such order identification. This order identification reading is indicative of a request to retrieve the order. A delivery device associated with the system computer displays data indicative of the storage location where the order is stored and then removes the order from the list of open orders, indicating that the order has been delivered.

In some aspects the order includes a plurality of orders, each order associated with a second time indicative of a length of time allocated to preparation of the corresponding order. This order fulfillment device further generates a ranking of the plurality of orders based on the first time and the second time associated with each one of the plurality of orders. In some aspects a location module is associated with the system computer and determines a location of the user associated with at least one of the plurality of orders. The order fulfillment device adjusts the ranking based on an adjusted first time, the adjusted first time based on a distance between the movie theater and the location.

The order identification may be a QR code, a barcode, a text code, Near Field Communication, Bluetooth or combinations thereof. The system may further include an order sharing module associated with the system computer which allows the user to designate at least one second user who is authorized to pickup the order. The order sharing module further generates at least a second order identification for each of the at least one second user, each second order identification different and different from the order identification. The system computer reads the second order identification as indicative of a request to retrieve the order.

The reader may use Near Field Communication, Bluetooth, or Wireless communication instead of, or in addition to, the QR Code and any other communication protocol described herein.

In other aspects a system is provided for delivering pre-ordered concession items and includes a system computer in communication with a user computer via a network. The system computer has software executing thereon. The software receives an order via the network and the order is indicative of at least one concession item and a first time indicative of when a user submitting the order would like to pick up the order. The software determines a storage location for the order and transmits data for display to a fulfillment device, the data indicative of the order and the storage location. The software further receives an order identification from a reader, the order identification indicative of a request to retrieve the order. The software further generates location data for display, the location data indicative of the storage location where the order is stored. The location data is transmitted to: the storage location, a display, a printer or combinations thereof.

The storage location may be a shelf. The storage location may be a locker where upon receiving the order identification, the software unlocks the locker such that the user can retrieve the order from the locker.

In some cases a fulfillment identification is received by the software via the fulfillment device, the fulfillment identification indicative of the order being available for pickup in the storage location. The fulfillment identification may include a start identification and an end identification, the end identification indicative of the order available for pickup, the start identification indicative of the order is about to be assembled, offering the user a final opportunity to make changes.

The system may receive a plurality of orders, each order associated with a second time indicative of a length of time allocated to preparation of the corresponding order. The software further generates a ranking of the orders based on the first time and the second time associated with each order. The second time may be updated based on a difference in time between the start and end identifications for a plurality of orders.

In some aspects the second time includes a preparation time and a buffer time, which may be predetermined by the venue. The software further adjusts the buffer time based on the number of orders due within a time range.

In other aspects a method is provided for pre-order and delivery of movie theater concession items. The method may include one or more of the steps of: providing a system computer having a software application executing thereon, the software application accessible by a user from a user device; receiving an order from the user via the software application, the order indicative of at least one concession item and a first time, the first time associated with at least one movie show time; calculating via the software application a second time associated with an amount of time allocated to preparation of the order; displaying the order via a display device at a third time, the third time before the first time by an amount at least equal or greater than the second time; associating the order with a storage location via the software application; receiving an order identification associated with the order at the software application, the order identification indicative of a request to pick up the order;

The method may further include displaying visual indication associated with the storage location at the display device, at a second display device or at the storage location. In other aspects, the method includes adjusting the third time based on a location associated with the user device.

In some aspects, the storage location is a locker and the method includes transmitting a request to open the locker via the software application after receiving the order identification.

In some aspects, a first side of the locker is configured to receive the at least one concession item therein for placement in the locker and a second side of the locker is unlocked upon transmission of the request to open the locker, via Near Field Communication, Bluetooth, personalized code, Wireless communication, scanning the QR code or another similar method.

The method may further include generating a second order identification associated with the order upon receiving a request to share the order with a second user. Further, receiving the second order identification is indicative of a request pickup of the order.

### BRIEF DESCRIPTION OF THE DRAWINGS

FIG. 1 is a functional flow diagram according to ordering and fulfillment features of the present invention.

FIG. 2 is a functional flow diagram of the system in FIG. 1 showing the order pickup process.

FIG. 3 is method process diagram according to the system in FIGS. 1-2.

FIG. 4 is a method process diagram according to the system in FIGS. 1-2.

FIG. 5 is a flowchart that reflects the general process according to FIGS. 1-1.

FIG. 5a is a representative user interface of an administrative page according to the system of FIGS. 1-5.

FIG. 5b is a representative user interface of the software displayed on at the venue according to the system of FIGS. 1-5.

FIG. 6 is a representative user interface of a login screen according to the system of FIGS. 1-5.

FIG. 7 is a representative user interface post-login screen according to the system of FIGS. 1-5.

FIG. 7a is another representative user interface of a post-login screen according to the system of FIGS. 1-5.

FIG. 8 depicts the venue selection screen according to the system of FIGS. 1-5.

FIG. 8a shows the venue/date selection screen for an internet user according to the system of FIGS. 1-5.

FIG. 9 depicts the date selection according to the system of FIGS. 1-5.

FIG. 10 shows the movie selection screen according to the system of FIGS. 1-5.

FIG. 10a the movie selection screen for an internet user according to the system of FIGS. 1-5.

FIG. 11 shows a movie time display according to the system of FIGS. 1-5.

FIG. 11a shows the movie time display for an internet user according to the system of FIGS. 1-5.

FIG. 12 shows the item selection screen in drop-down menu form according to the system of FIGS. 1-5.

FIG. 13 shows the expanded drop down menu according to the system of FIGS. 1-5.

FIG. 13a shows the ordering screen for an internet user according to the system of FIGS. 1-5.

FIG. 14 shows the slide menu that provides the user with a tally of existing items in his/her tray according to the system of FIGS. 1-5.

FIG. 15 is an order summary page according to the system of FIGS. 1-5.

FIG. 15a is the pop-up clock that the allows the user to change his/her pickup time according to the system of FIGS. 1-5

FIG. 15b shows the summary page for an internet user according to the system of FIGS. 1-5.

FIG. 16 is a confirmation page according to the system of FIGS. 1-5.

FIG. 16a shows the confirmation page with the QR code for an internet user according to the system of FIGS. 1-5.

FIG. 17 shows an example hierarchy for order fulfillment according to the system of FIGS. 1-5.

FIGS. 18 and 19 show example interfaces allowing purchase of movie tickets according to the system of FIGS. 1-5.

FIG. 20 is an example user interface used for order pickup according to FIGS. 1-5.

FIGS. 21-22 are example user interface screens for an administrator page according to the system of FIGS. 1-5.

FIGS. 23-27 are example user interface screens for the order fulfillment and delivery devices according to FIGS. 1-5.

### DETAILED DESCRIPTION OF THE INVENTION

The following description of embodiments of the invention is not all-inclusive nor is it intended to limit the potential uses and applications of the invention. It is intended to provide initial uses of the invention by means of examples without limiting the invention to any particular embodiment.

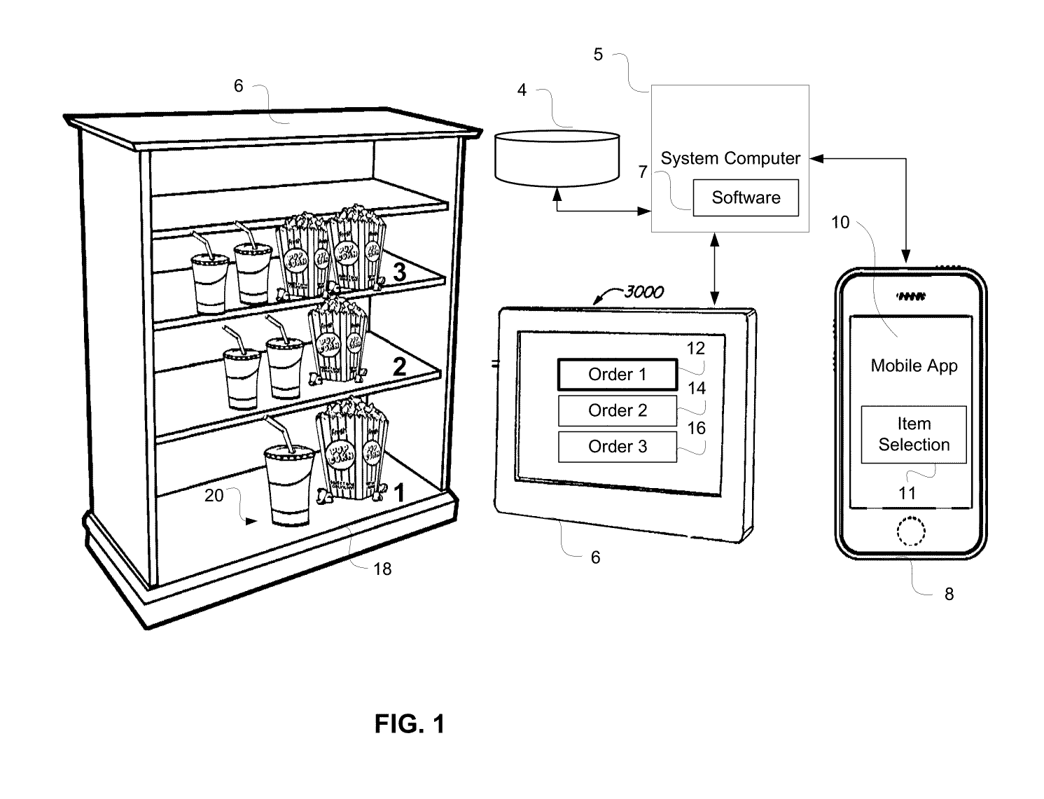

As shown in FIG. 1, a system computer 5 has software 7 executing thereon. Mobile device 8 can access the system computer via a mobile application 10. In other embodiments a web interface allows the user to access the software from a web browser on the same or a different type of user device such as a laptop, desktop, tablet, smartphone or other device. In some cases, some elements of the software execute directly on the user device. The software allows the user to select venues, show/game times, purchase movie tickets, select order pickup times and concession stand items. For example, the user can use the item selection interface 11 provided by the mobile app 10 to select the concession items they would like to purchase. The user can also submit payment or an authorization to charge a credit/debit card or other account for the cost of the concession items. The system computer has a database 4 in communication therewith. The database stores information on the orders received. The software 7 further determines a preparation time based on the aggregate amount of the individual preparation times of each of the items selected by the user.

For example, the fulfilled order shown on shelf 3 includes two popcorns and two sodas. It would be expected that this would take longer to fill than the order on shelf 1. In addition, buffer times may be added such that the order will be completed prior to the user's pre-selected pickup time, and accounting to a surge of orders. Therefore, the system will direct the employee fulfilling orders to do so in advance of the designated pickup time by a combination of the buffer time and the total preparation time.

Display 3000 shows three orders 12/14/16 in the queue. As can be seen, order 1 is distinguished visually such that the employee knows that it is time to assemble order 1. The employee may select order 1 and then the display may show what items are included in the order. For example, a large popcorn and large soda as shown on shelf 1. The display may also show which shelf number should be used for fulfillment of the order. Although display 3000 is shown, it is also understood that the system could also include a printer that creates a physical ticket for the employee filling the order. Once the order is placed on the shelf, the employee may select the next order or indicate that the particular order is finished. The database 4 can also store information on the actual order assembly time and over time, the designated preparation time per item can be more precisely determined either on a theater by theater basis or specifically by employee.

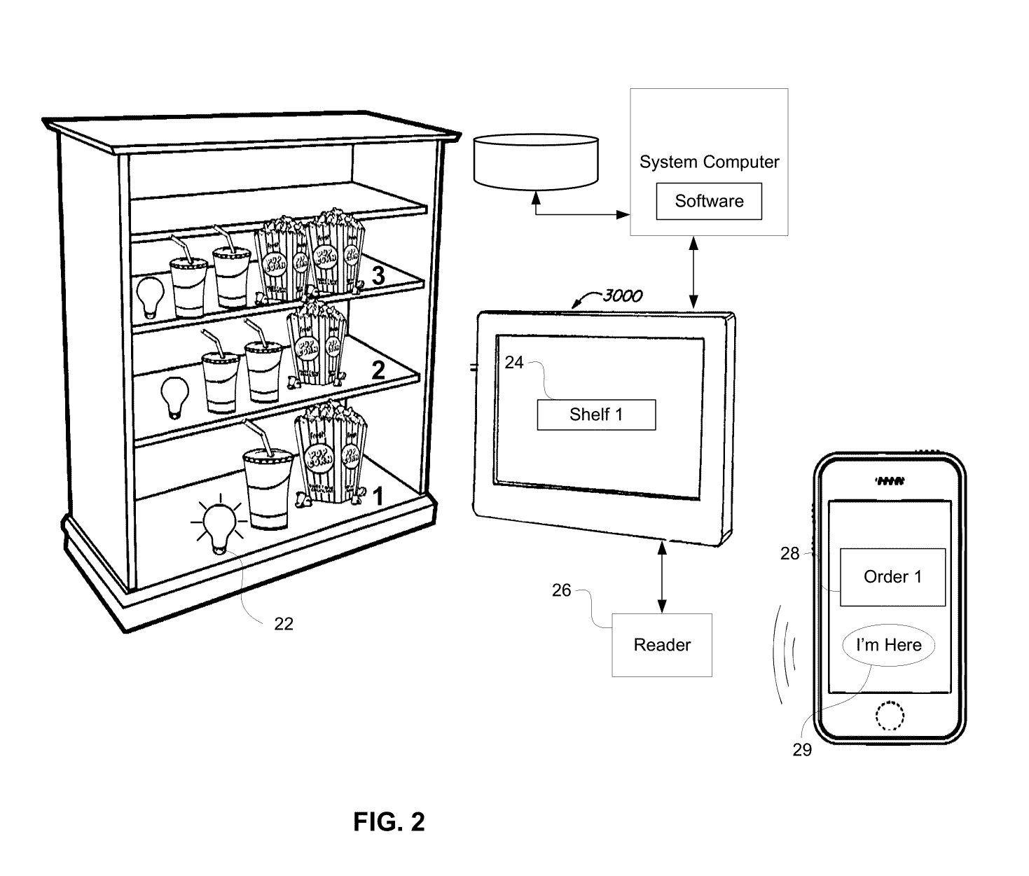

When filling the order, the shelf or the tray or a removable accessory temporarily attached to the tray could also use lights or other visual/audible cues to designate particular shelves. For example, the light (FIG. 2) could turn one color to designate that the order being fulfilled should be placed on the associated shelf and the light could turn a different color to designate when a customer is picking up the order on the shelf. In addition, the order could be fulfilled using a tray and that tray could include lights that activate when the order is fulfilled and to indicate which tray should be used for fulfillment. In another embodiment, an accessory can be temporarily attached to the tray that includes a light that flashes when the applicable order identifier is activated, to alert the employee as to the location of the tray that corresponds with that particular order. The tray/light may communicate wirelessly with the system computer via WiFi, SMS, cellular or other communications protocols.

In some embodiments, when the employee chooses to fulfill an order, payment may be processed upon fulfilling or beginning to fulfill the order.

It is also understood that shelf 6 may be a locker or otherwise closed or semi closed storage location that allows for self service pickup as discussed further herein. For example, the rear side of the shelf 6 is show in the locker example in FIGS. 1 and 2. This may be the employee facing side where the orders are filled. There may be a door on the other side that is unlocked/opened when the system receives the order identification. It is further understood that the light 22 can be placed on the outer (user facing) side in the locker example.

The listing of orders 12/14/16 on display 3000 can also be adjusted based on a number of factors. For example, the user can select a pickup time and based on the assembly time determined (which may include a buffer time), the system would know when to instruct the employee to fulfill the order. However, the user may be early or late to the venue. If the user is late, the food would be sitting on the shelf longer and may get cold or the ice in the soda may melt. But, if the user is early, they would need to wait for their order to be fulfilled. When the user submits the order via a smart phone or associates a location enabled mobile device with the order, the system can track the location in comparison to the movie theater. If the user is moving towards the movie theater earlier than expected, the system can move their order up on the queue. If the user is running late, the order is moved lower in the fulfillment queue.

Referring to FIG. 2, the system is shown when the user picks up their order. The user device is shown with order identifier 28 displayed thereon. The reader 26 may be a barcode/QR scanner that reads the order identifier 28 (which may be a barcode/QR code). In some embodiments, the system is configured to operate with near-field communication or other wireless technologies to communicate the order identifier to the system. The reader is shown connected to the display 3000. It is understood that the reader can be built in to the display 3000. It is also understood that although display 3000 is shown in FIGS. 1 and 2, a fulfillment display and an order pickup display could be in different locations. For example, in the storage locker example, the display used for fulfillment of orders may not be user facing because only the employee needs to see the order information for fulfillment and placement in the appropriate storage location. A second display may be associated with the reader 26 near the lockers such that the system operates as a self-service kiosk for pickup. In another embodiment, the appropriate reader can be a component of each individual locker such that the user can go directly to the assigned locker and retrieve the order using Near Field Communication, Bluetooth, a personal code, QR code, barcode or some other order identifier as described herein.

It is also contemplated that the display 3000 could be a touch sensitive display or that a keyboard or other input device is provided that allows the user to enter a code as the order identifier. Another input device such as a keyboard, mouse and others may be provided for use by the employee.

Once the order identification 28 is received, the software determines where the order is stored and displays the storage location 24 on the display 3000. In some cases, visual cues such as a light 22 may locate the particular storage location. As can be seen, the light 22 is active whereas the lights on shelves 2 and 3 are not. In the locker example, the appropriate locker would be opened/unlocked to allow the user to retrieve their order (lights or other cues may also be used). In some embodiments, each locker has a reader/input device that receives the order identifier. In this scenario, the user device would display the storage location and the user would use the order identification 28, which may be a barcode, QR code, or personal code, Near Field Communication, Bluetooth or other order identifier as the case may be, to open the assigned locker.

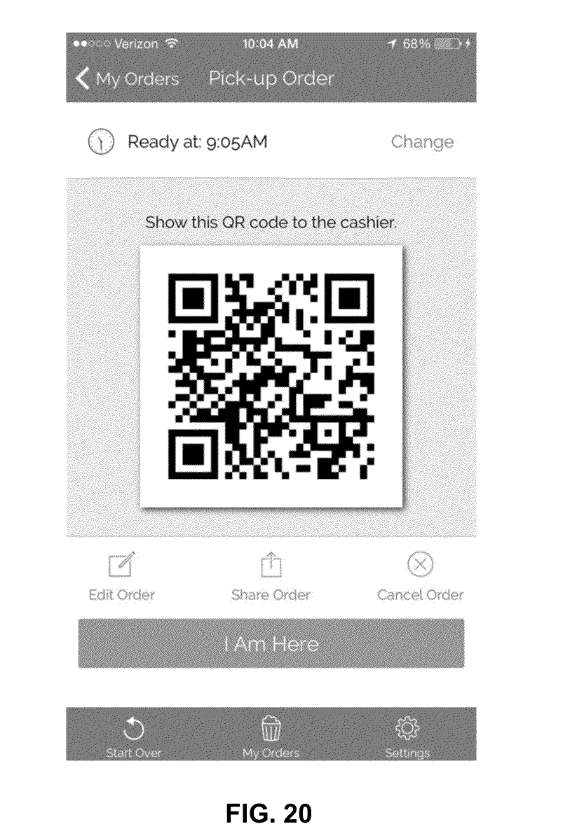

In some embodiments, the mobile application on the user device is also shown with an “I'm Here” button 29. Upon selection of this button, the order ranking discussed further herein would push the user's order up to the top of the queue to be sure the order is prepared for pickup (if the order has not been prepared already). This action can be undone, prior to the fulfillment of the user's order, by simply changing the pickup time as shown in FIG. 20.

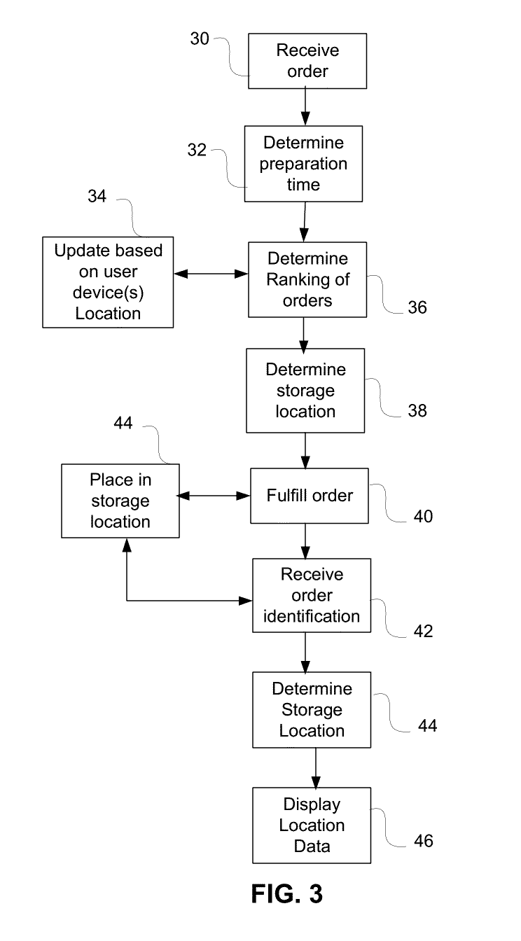

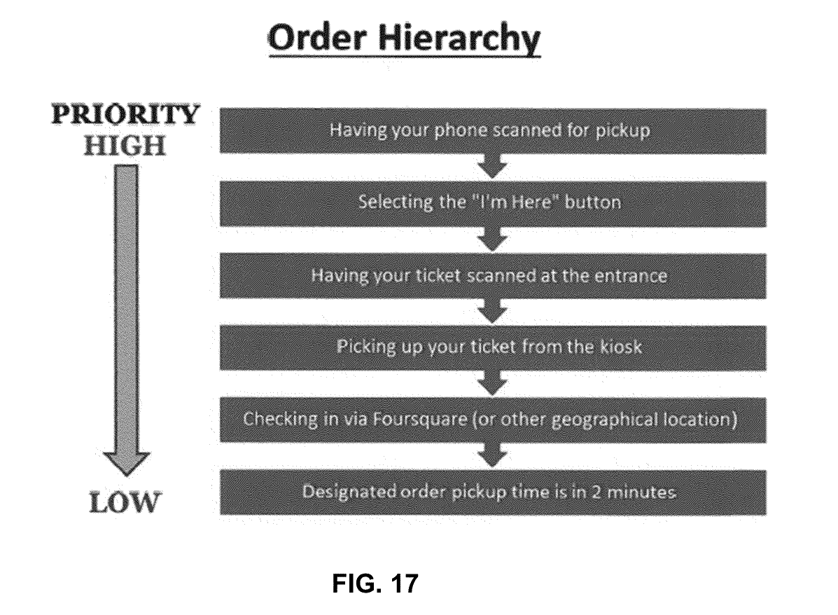

In FIG. 3, an exemplary process diagram is shown. As shown, the order is received 30 via the mobile application or a website and submitted to the system computer. The system determines the preparation time 32 for the order based on which items were purchased. The preparation time may also include a buffer time. The buffer time may be fixed, for example, 5 minutes, or the buffer time may increase as the number of orders within the same or similar pickup time amass. For example, if there are 10 orders that each take 1 minute to prepare that are all due for pickup at the same time, the system would designate particular orders for earlier fulfillment, for example 15 minutes before pickup time. In some cases, the orders selected for earlier fulfillment would depend on the food type ordered. As one example, an order of candy only would be fulfilled before an order containing hot or cold items. An order with soda in ice may be fulfilled after an order for popcorn, as the soda sitting around for too long may result in the soda becoming watered down due to ice. Different products may be assigned different shelf time scores such that based on what is ordered, the system can prioritize the fulfillment of orders to provide the best customer experience. The system can be configured such that the shelf times scores are configured or adjusted. All of these properties can be used to determine ranking of the orders 36. The ranking may also be determined further based on the hierarchy shown and discussed in FIG. 17.

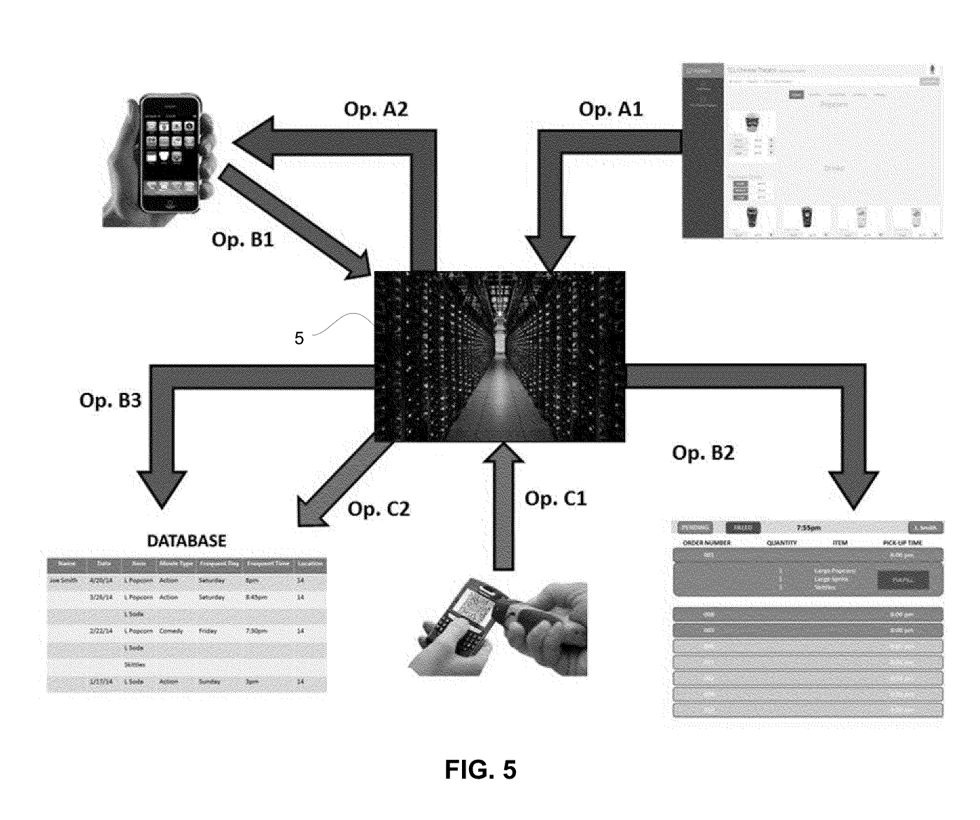

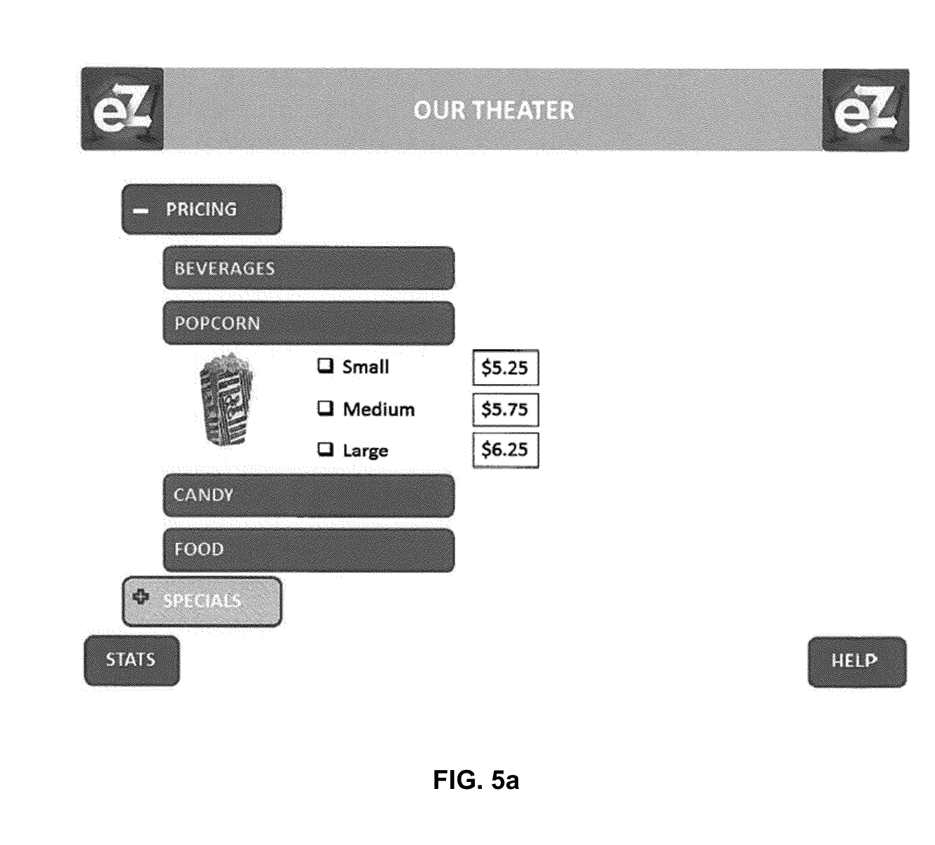

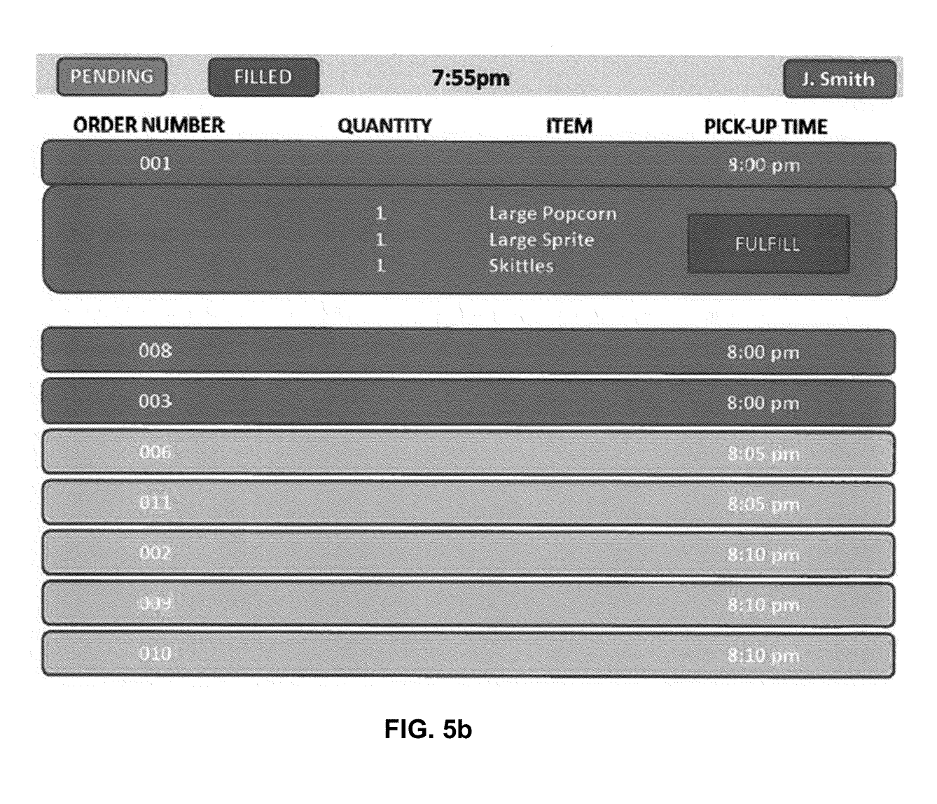

The ranking may be updated based on the user device(s) location 34. For example, one order in the system may move up in the queue when the user is closer to the theater than other users with orders in the system. In a similar implementation, the position of an order in the system might move within the queue due to the actions of the user such as changes made to the items in the user's order, altering the schedule pickup time, tapping the “I'm Here” button shown as button 29 in FIG. 2, or scanning the user's QR code or other order identifier at the concession stand. Then, by tapping “Fulfill” in FIG. 5b, the system determines a storage location 38 for the order based on which shelves/lockers are available. Typically, the orders will be placed in the lowest numbered shelf available. For example, if an order is picked up from shelf 1 and shelves 2-5 are full, the system would assign shelf 1 to the next order rather than shelf 6. However other storage location assignment rules can be applied.

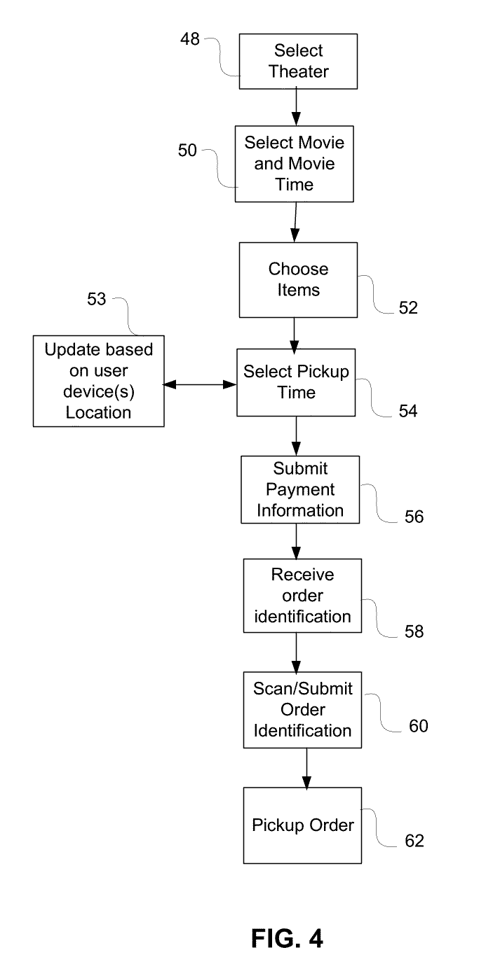

The order is then fulfilled 40 according to the ranking. Typically, an employee will select to fulfill the order causing a printer to create a ticket. The order is then placed in the assigned storage location 44. Once the user arrives and the order identification is received 42, the system determines where the order is stored 44 and displays location data 46 which may be simply shelf number or may cause the light/visual cues to become activated. Although FIG. 3 is shown with the storage location being determined before fulfillment, it is understood that the storage location may be determined after the order is fulfilled. It is further understood that the particular order shown in FIGS. 3 and 4 may be modified and the steps may be performed in other orders.

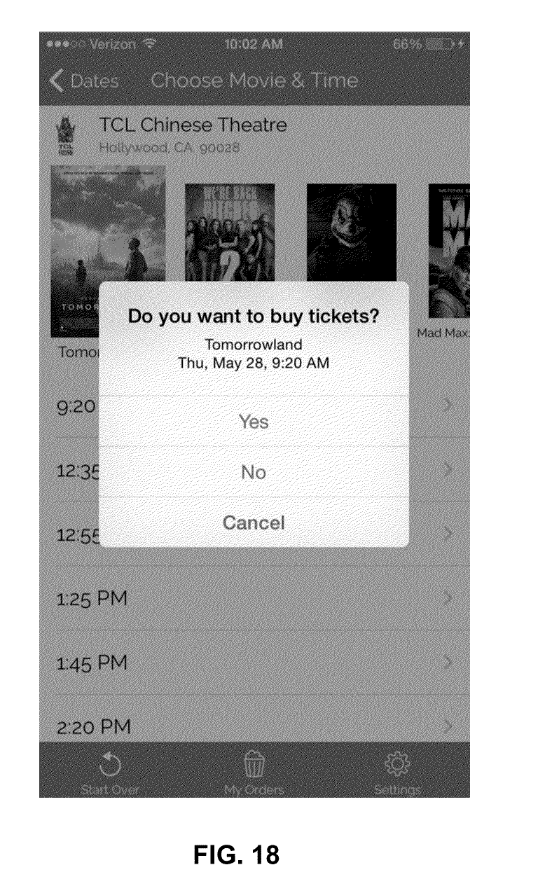

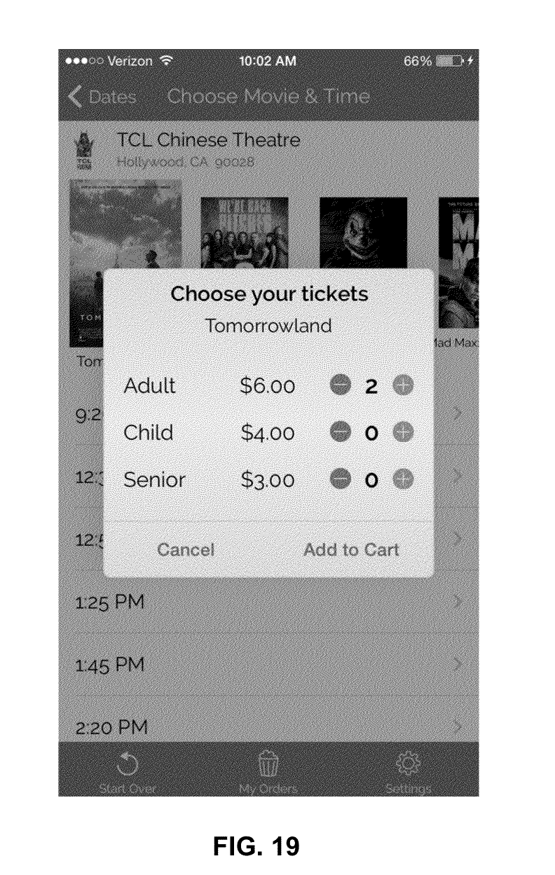

FIG. 4 shows the process performed by the user. The theater is selected 48 and the movie and movie time is also selected 50. In some instances, the user may be provided an option to purchase tickets at this point. See FIGS. 18 and 19. If the user selects yes, a pop-up appears displaying the different ticketing options and prices available, at which point the user may select the appropriate type and quantity of tickets (See FIGS. 18, 19) and the proceed to choose items 52. If the user declines to purchase tickets, the user then chooses items 52 and selects a pickup time 54. The system may default to a pickup time 5 minutes before the movie, which default may be adjusted by the user in the profile section of the application. The system may also be configured to adjust the default pickup time based on various external factors such as the number of orders already selected for pick-up at that time or the number of tickets sold for the movie. For example, a full movie may default to earlier pickup times to reduce the possibility that too many orders are due at the same time. The pickup time may also be updated based on user location 53 as determined by the user device, which may have a GPS installed therein or other location sensor. The user submits payment information 56 or authorizes payment. The user account may already be associated with a particular payment method such that the user does not need to input payment information again. In addition, mobile payment systems such as Apple Pay may be integrated such that the user can enter a verification code or use a biometric scanner to verify payment authorization. The system generates an order identification 58 for the user. The system may also be configured to generate additional order identifications where the user can share the order with their friends, which allows for an individual authorized by the user to pickup the order with a unique order identification that is associated with the order. When the order is picked up, the system can also notify the other users that the order was shared with that the order was picked up and by whom. The mobile application may include a share order button similar to the “I'm Here” button that upon selection allows the user to share the order with other users either directly into the “My Orders” section of the recipients application or via e-mail, sms or other messaging form.

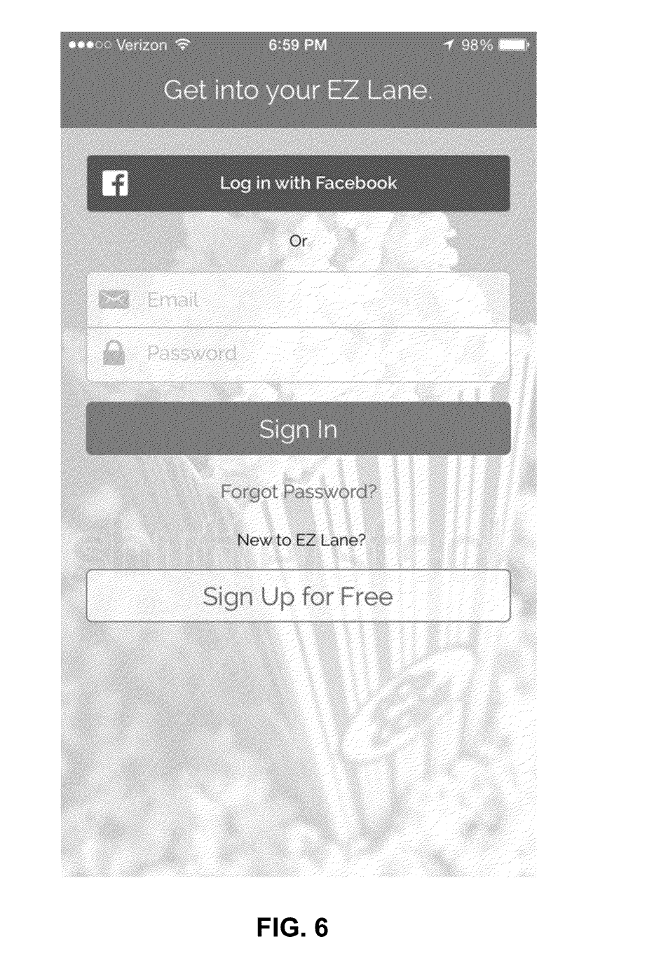

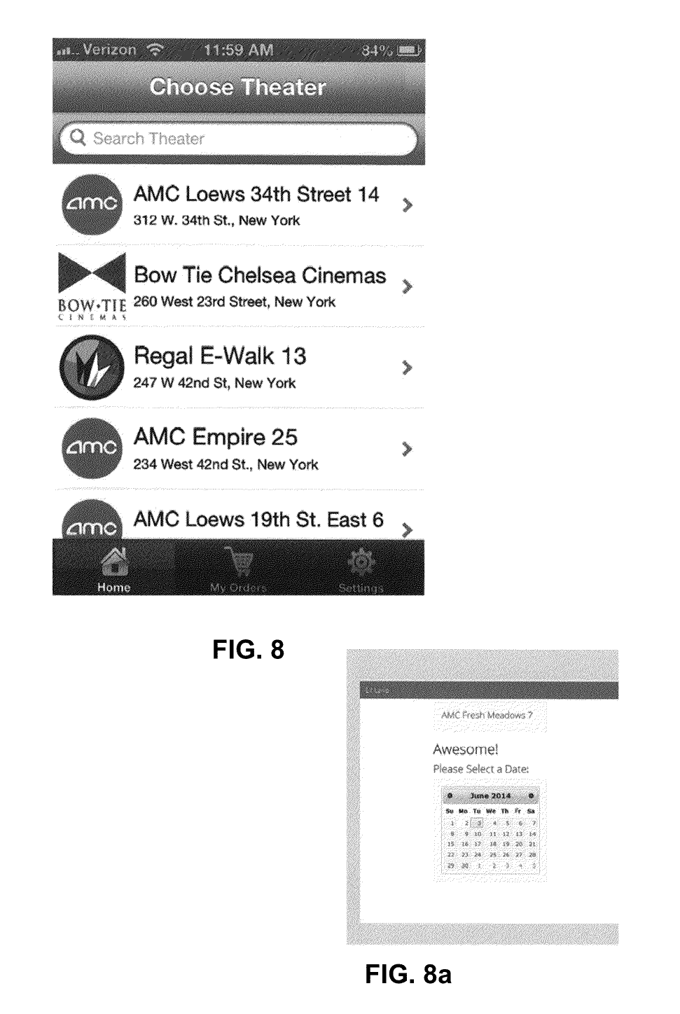

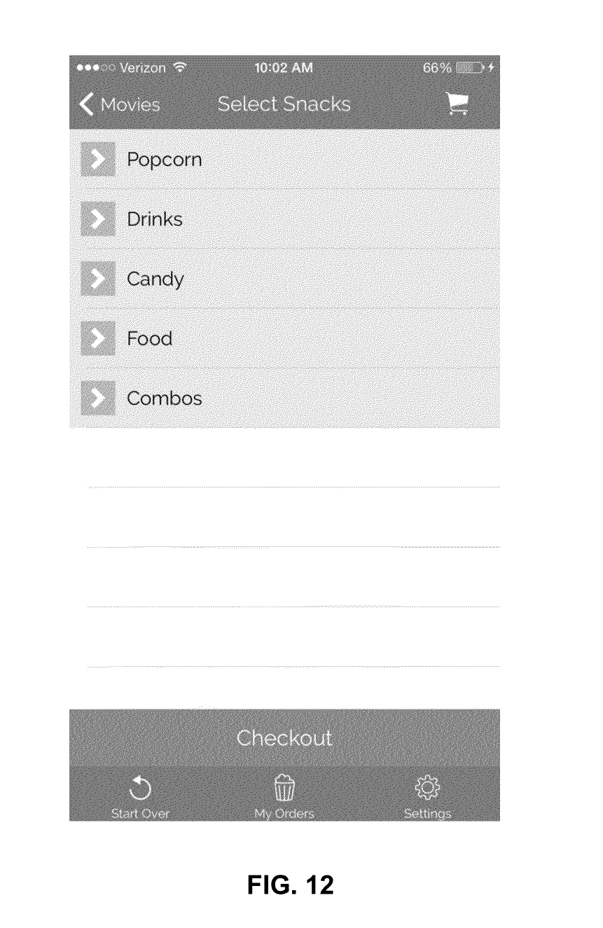

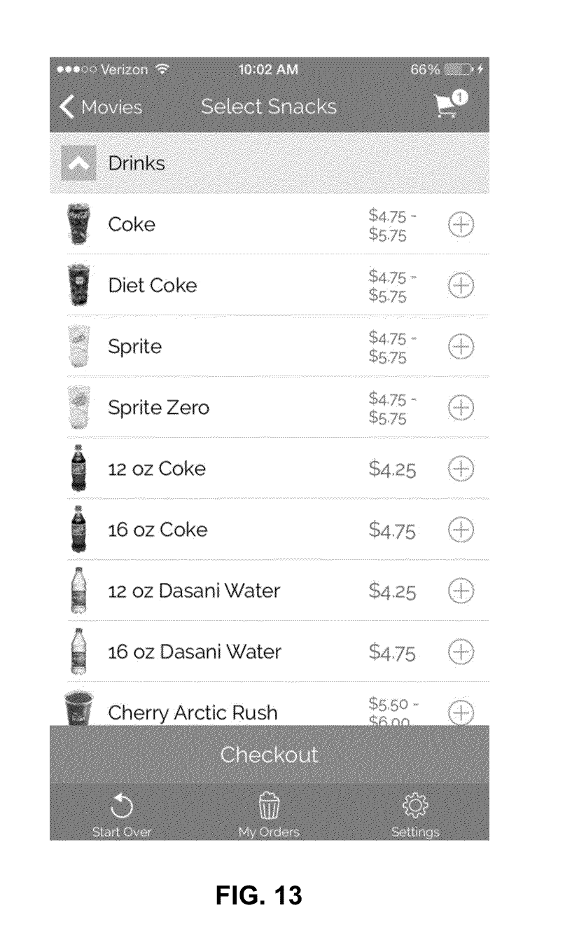

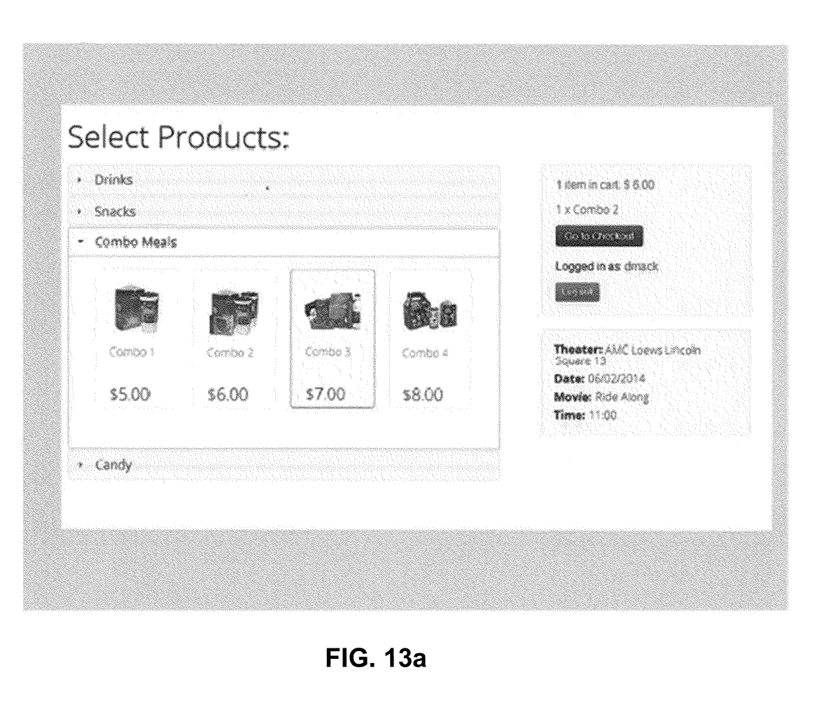

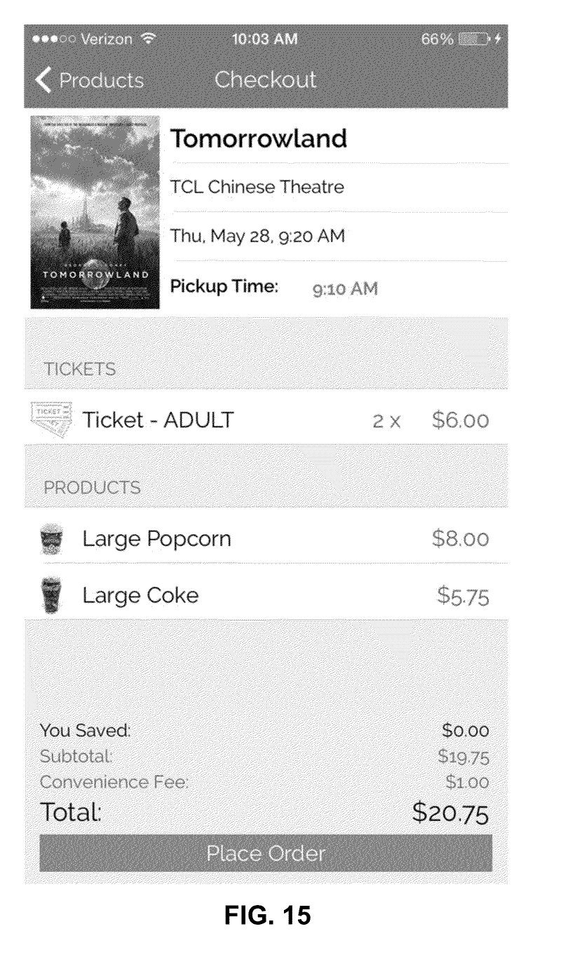

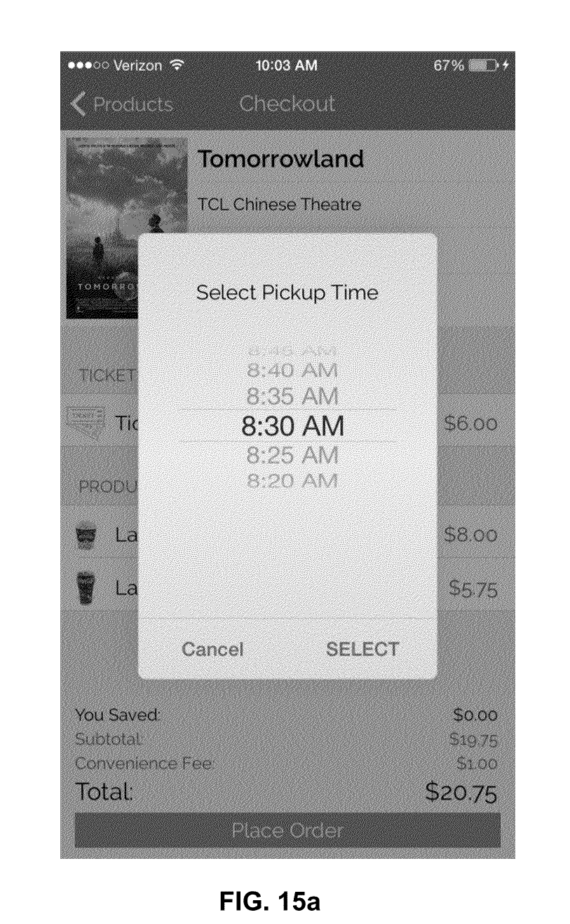

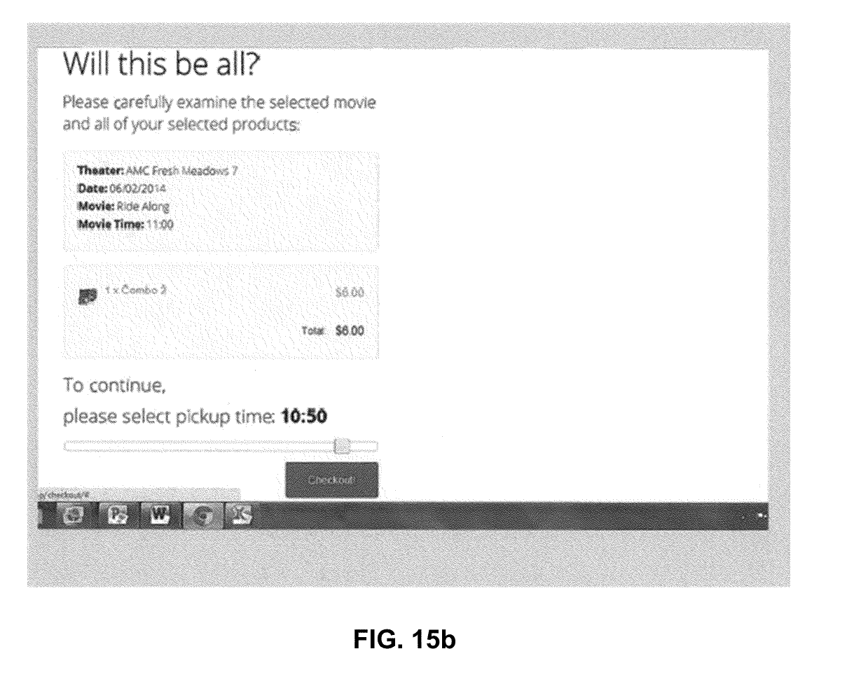

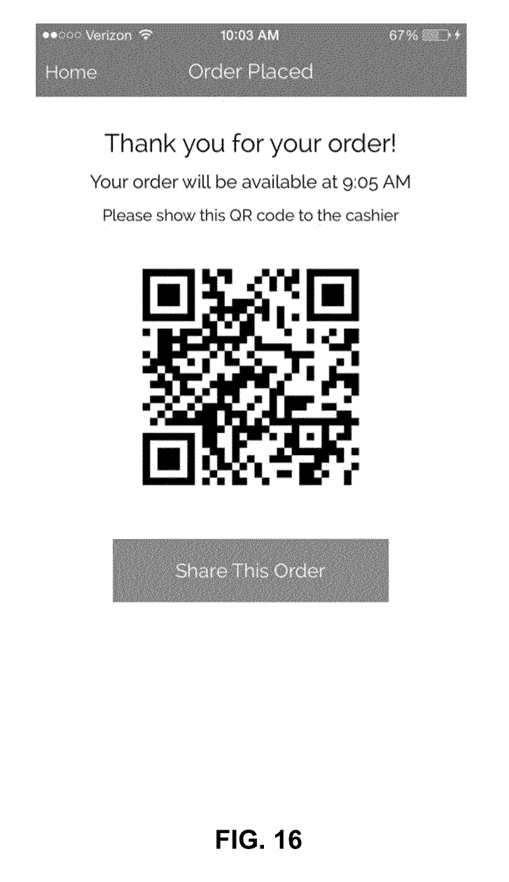

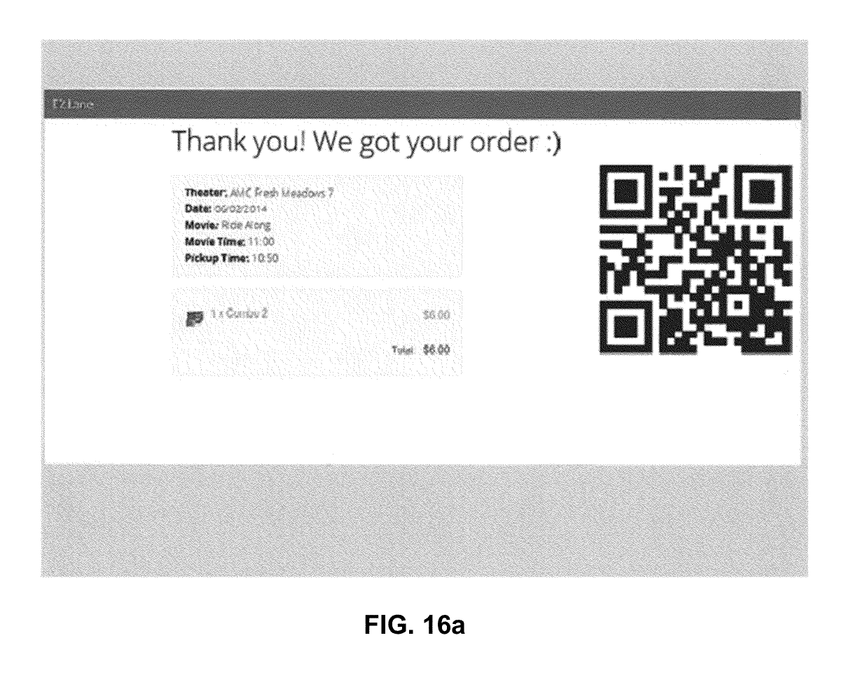

In the process of submitting payment or payment authorization, the general process for the customer using the invention at a movie theater includes: (A) Logging into the site to access the user's profile per FIG. 6; (B) Selecting the theater, date, movie, and time, per FIG. 8-11; (C) Scrolling through the menu and selecting the user's desired concessions per FIG. 12-13; (D) Selecting the pickup time per FIG. 15-16; (E) Retrieving the order at the designated location at the theater; and (F) Having the user's QR code scanned and the order retrieved. This process would be the same at other venues, except for Step B herein which may include a venue/showtime selection. Additionally, in Step D, there may be options for immediate pickup time and delivery options to a specific seat or location.

As shown in FIG. 5, the process incorporates various inputs and interactions via an Application Programming Interface (API). In the initial input, a venue manager accesses the Administrator Page shown in FIG. 5a to alter pricing, add or subtract items, create food combos, which may offer improved pricing over a la carte ordering, or offer special promotions, which changes are automatically updated via the servers/system computer 5 as depicted in Op. A1. Those modifications are then transmitted by servers to update that venue's unique menu via Op. A2 to ensure that the user is provided real-time offerings and pricing while ordering either on the website or mobile application. The secondary input involves the transmission of the customer's order seen in Op. B1, which is then processed through the servers with the information ultimately sent concurrently to two separate destinations. The first destination, shown in Op. B2, is the venue's tablet or computer where the order will be listed in a preference hierarchy as described in FIG. 17. The second destination, shown in Op. B3, is the database that will collect and save the order information for each customer, which can be sorted for marketing and operational purposes. An additional input applies to the retrieval process, which begins, as shown in Op. C1, with the scanning of the user's QR code or other order identification to recognize the applicable order to be collected. Upon scanning, depending on the venue, the tablet screen will direct the concessionaire to a shelf or other storage that houses the specific tray that corresponds with the scanned order or a light source, clipped to the tray at the time of order fulfillment, will flash until the tray is appropriately retrieved for delivery. As such, the information regarding the pickup time will be provided to the company's database per Op. C2 to maximize operational performance.

As shown in FIG. 6, the first step in the mobile application may require the creation of a profile or, if previously formed, logging in to an existing account. Among other things, a user can enhance his/her profile by saving favorite venues, providing information such as an email address and date of birth, accessing previous orders, saving payment information for future orders, adding guest rewards or club information for different venues, selecting default pickup times relative to the start of a movie/event, and uploading a unique picture.

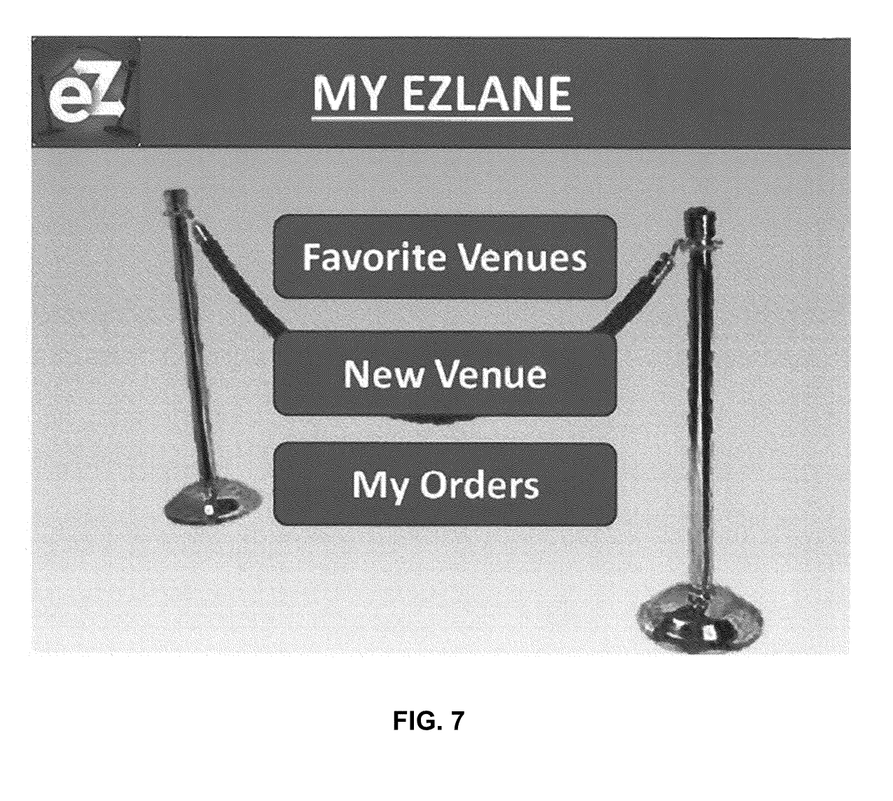

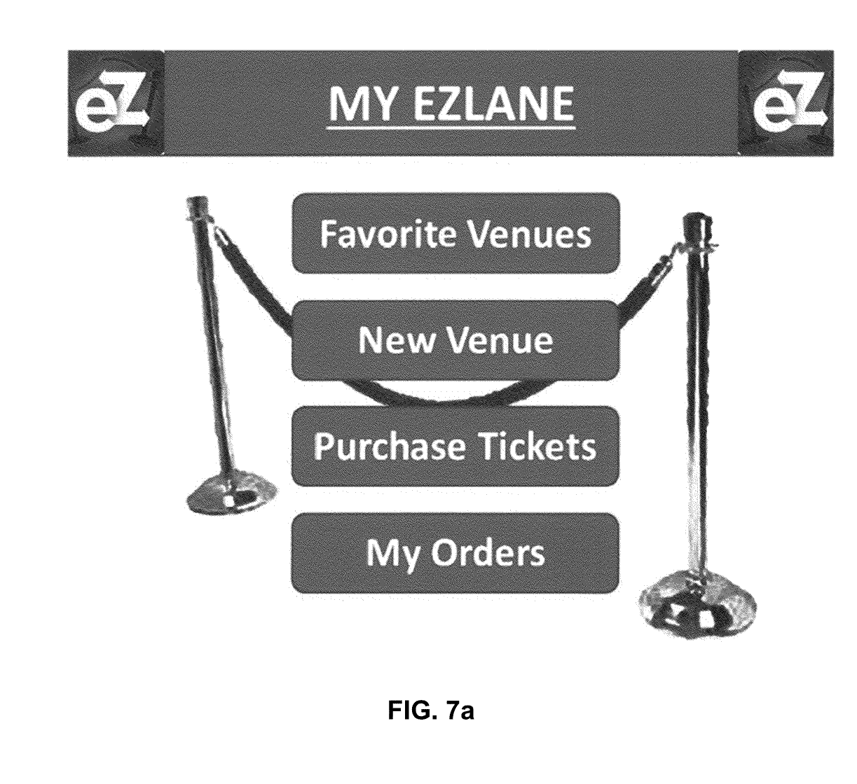

As shown in FIG. 7/7a, after logging in, the user may (1) select from the previous venues he/she has visited; (2) select a new venue based on type of venue, such as movie theater or stadium/arena, or geography; or (3) access existing orders for modification or pickup.

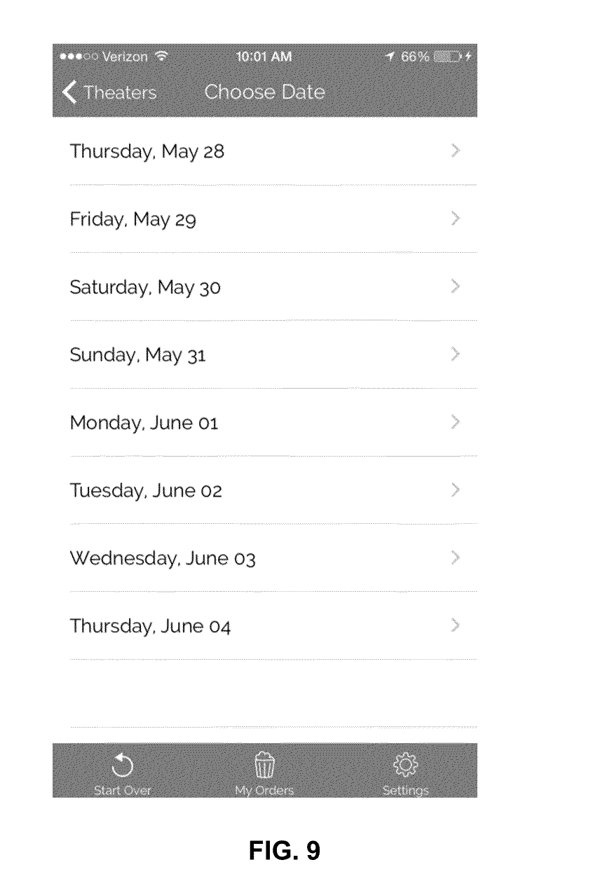

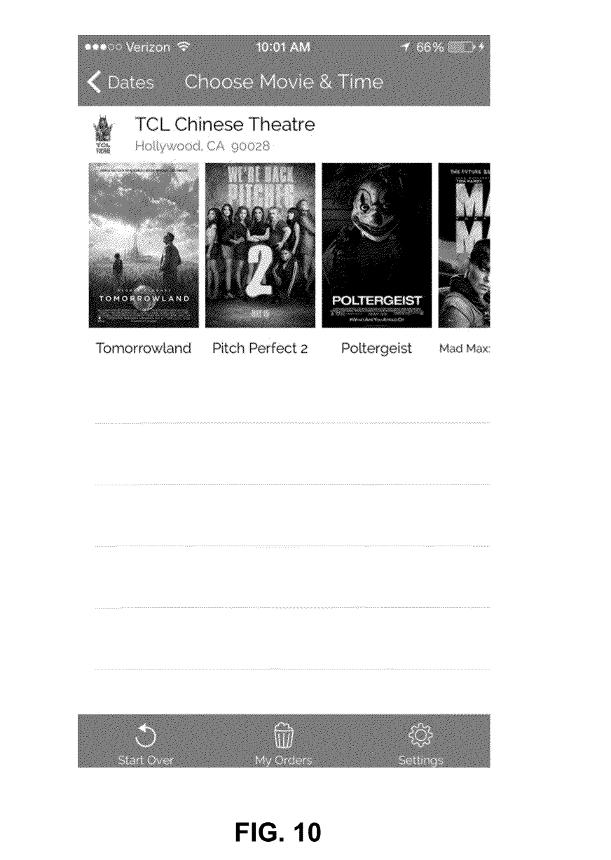

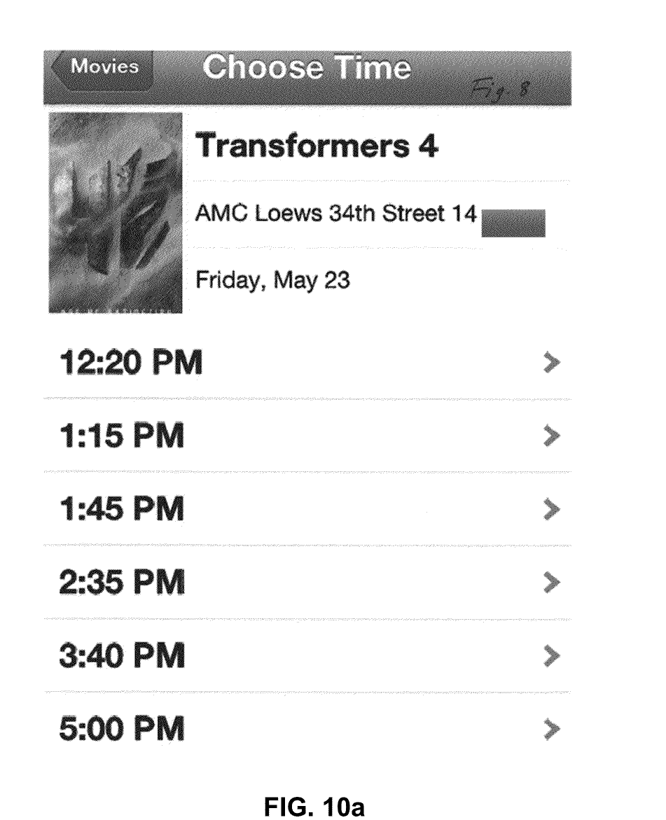

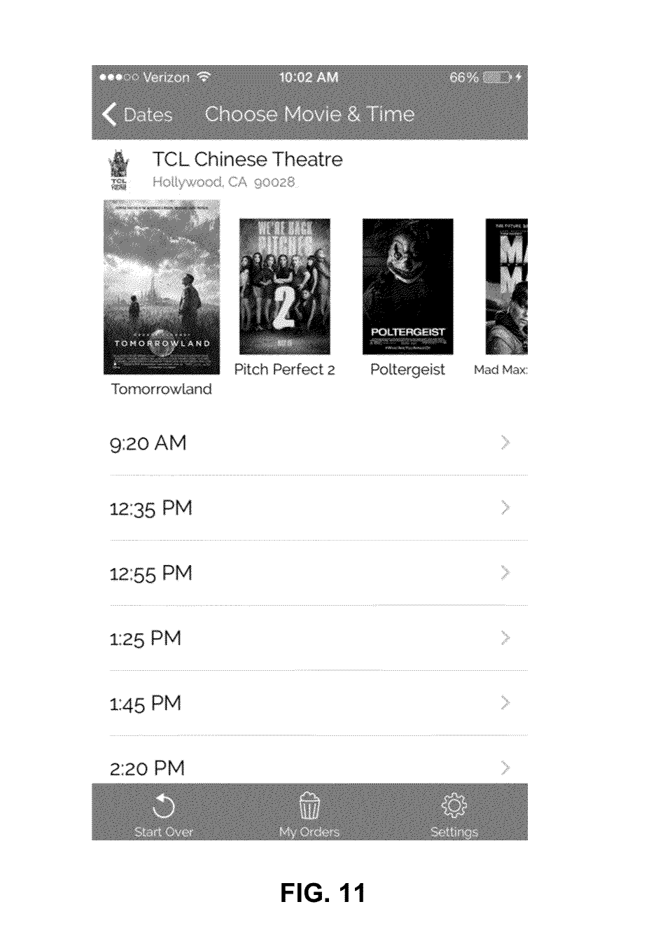

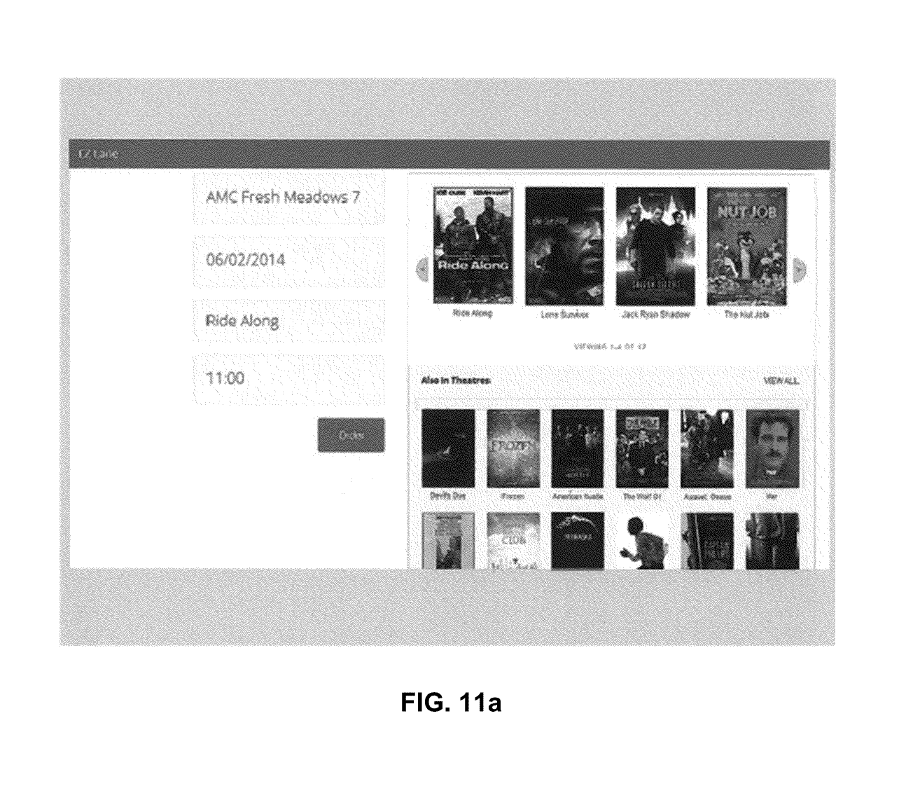

In particular, specific to the theater-going experience, after selecting a “new venue” in FIG. 7a, FIG. 8/8a shows the process by which the user would scroll to find the applicable theater that he/she is visiting, then select the date which would narrow down the list of movies or events as in FIG. 9, and then, after selecting the applicable movie or event in FIG. 10, choose the appropriate showtime in FIG. 11. It is also understood that the theater list can be updated based on the location of the user, for example, the location of the user's mobile device.

In a similar implementation, for those orders being fulfilled via the internet, for example, Mac or PC, FIG. 8a shows the process for selecting the venue and date, FIG. 10a shows the movie selection page and FIG. 11a shows the time selection after the movie is chosen.

In another implementation, specific to the live-action experience at either an arena, stadium or similar venue, after selecting the venue in FIG. 7—be it a “Favorite Venue” or a new venue that proceeds a search—the user selects the date of the event, which leads to confirming the nature/title of the event—such as a sports game, concert, etc.—and the start-time itself. There may also be options to select intermediate pickup times at halftime or other intermediate times in sporting/theater events.

In another implementation, specific to the hospitality sector, after selecting the hotel in FIG. 7—be it a “Favorite Venue” or a new venue that proceeds a search—the user selects the date of delivery and the preferable time to have the order delivered or retrieved should the venue provide for such services. The user will then be provided with a menu that corresponds to the applicable meal—be it breakfast, lunch or dinner—and selects items from the relevant menu to complete the order. In this instance, if desired by the hotel, rather than charging the user through the application, the order and total charge can be added to the hotel folio of the applicable user/guest.

In another implementation, the system will enable the user to directly purchase the ticket for the event in question on the system. See FIGS. 18 and 19. In those instances, the user will, after logging in, select a “purchase tickets” option as shown in FIG. 7a and then select the venue, date and event or the user may be prompted to order tickets as shown in FIGS. 18 and 19. In the case of theaters, selecting the particular movie or showcase would then require the choosing of a showtime, whereas with concerts, sports events and other stadium/arena selections, the user would simply select the event he/she seeks to attend or may optionally select an intermission, halftime or other regularly scheduled break. These selections are incorporated into the ordering process

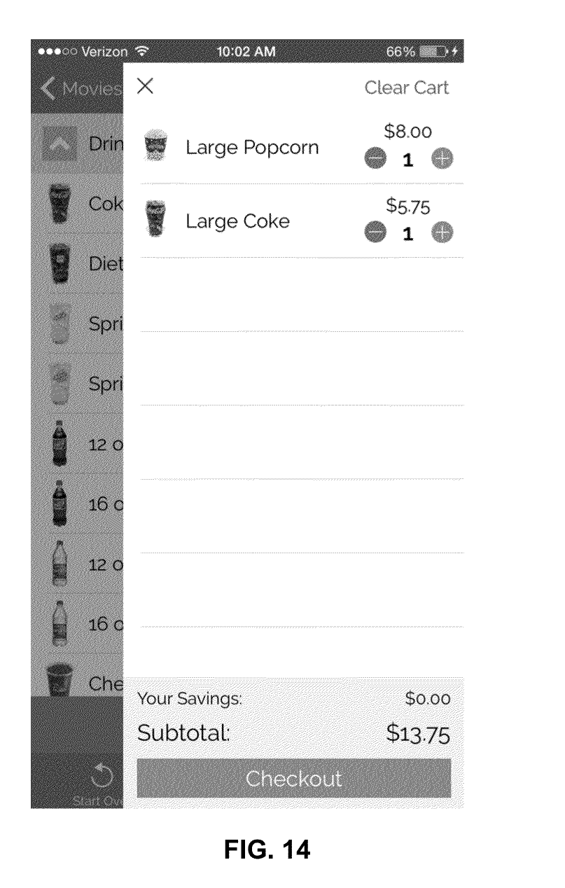

As shown in FIGS. 12-13 categories will be provided that shall enable users to easily locate and choose items. As each item and quantity (and size, if applicable) is selected, it is added to the user's tray or cart, which updates the subtotal of the order. That tray/cart can be viewed either by swiping across the screen or by tapping the cart icon in the upper right-hand corner of the screen as shown in FIG. 14. From that cart, the user will be able to add or subtract quantities of selected items without requiring the user to revert to the product-selection process.

In another implementation, when the user accesses the product using the website, the tray/cart shall be affixed on the active screen showing real-time updates to the user's tray/cart as shown in FIG. 13a. From that cart, the user will be able to add or subtract quantities of selected items without requiring the user to revert to the product-selection process.

In some implementations, nutrition facts are displayed and may be updated in the cart either with the applicable items, shown as a total amount, or both. This may simply include a calorie count for the order or a calorie count per person where the user has purchased multiple tickets. In some cases, a nutrition facts label may be displayed and updated based on the user's selections.

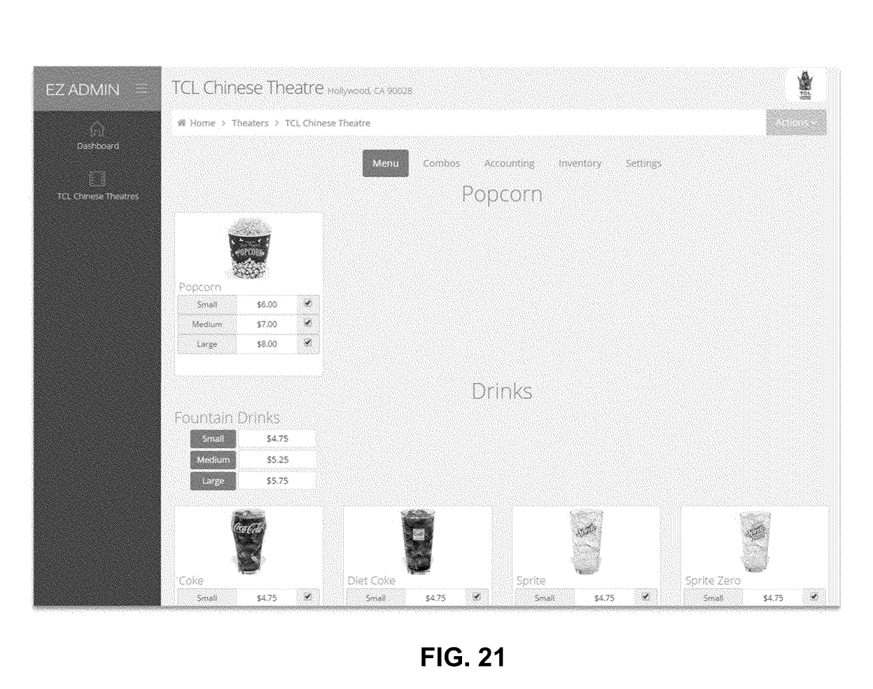

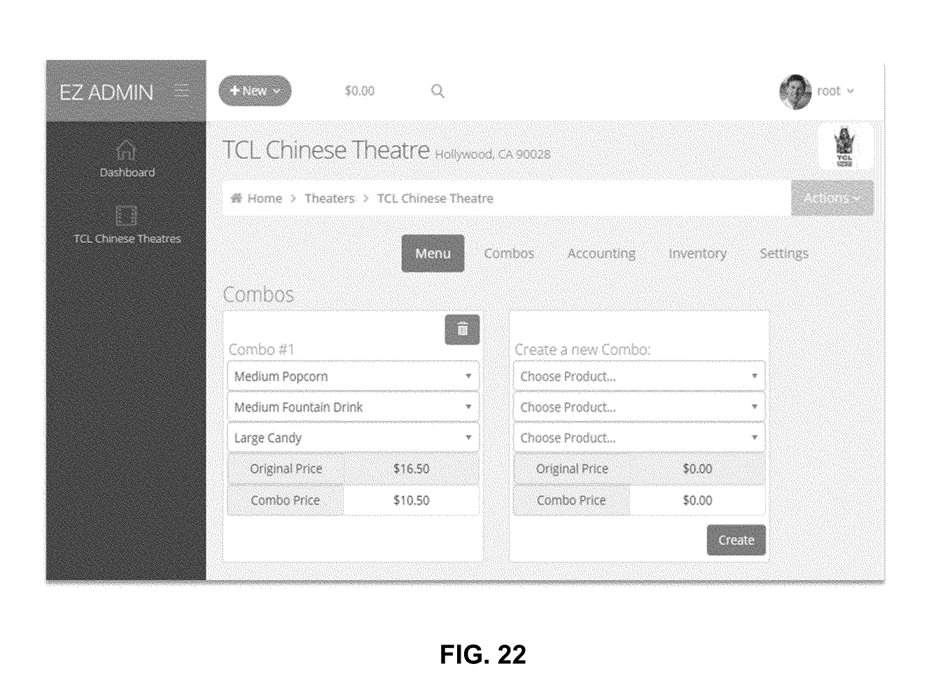

In another implementation, when the user selects a certain combination of goods pre-determined by the venue, or combo, a pop-up shall appear whereby the user selects the type of specific items. Such combos are created by the merchant on the Administrative Page shown as FIGS. 20 and 21. By selecting a combo rather than the itemized goods, the user is often receiving a reduced price and the difference is shown as a savings in the user's cart. In a similar implementation, the venue can opt to “up-sell” the user in cases of sized goods, alerting the user that, for only a certain amount of money more, the user can acquire the larger-sized version. Declining two “upsell” opportunities in row may deactivate any future “upsell” pop-ups in that session, and the user would thereafter have the opportunity to turn off such notifications in his/her user preferences.

Once the user has selected all of the desired goods for the order and selected the “Checkout” prompt, the user is redirected to the confirmation page. Prior to completing the order and submitting payment, the user is provided a summary of all previous selections including, but not limited to the event, venue, date, order information, and pickup time as shown in FIG. 15. If using the mobile application, the user may adjust the pickup time as shown in FIG. 15a.

In another implementation, where the user accesses the product using the website, the Checkout screen will also provide relevant ordering information such as the movie or event (as applicable), the venue, the date, and the order information as shown in FIG. 15b. In addition, regarding the pickup time, the user may also be provided a sliding scroll bar or other mechanism by which he/she can select the appropriate pickup time at the venue.

In the last step of the ordering process, upon completing the order, the user will be provided a QR code or other order identifier to verify the order at pickup, which might also include other order information such as the selected pickup time and a message thanking the user for their patronage. This screen may also include a “Share” button, which enables the user to send unique order identifiers to others such that those other people can retrieve the order, as described herein. While such QR code will be provided on the screen of the mobile application as seen in FIG. 16, it will also, be stored in the “My Orders” section of the application as provided in FIG. 7 for easy retrieval. Additionally, depending on the user's profile preferences, the same QR code may be sent to the users email address. Similarly, for those users ordering via the website, the user will have the option to print the QR code to submit at pickup or email it to the user's account (or both).

In another implementation, in the event that the user also uses the system to purchase tickets as seen in FIG. 7a, the same QR code may be used for both verifying attendance and retrieving one's order depending on the merchant's capabilities. In another implementation, the system may provide two separate QR codes or other order identifiers, one applying to the food portion of an order and the other applying to the ticket portion of the order. The methods used in this instance, for either food or tickets, may or may not be the same or similar.

As part of the confirmation method, the user has the option to share his/her order information with fellow users via his/her user preferences or as an option at checkout. Such option enables fellow users accompanying the purchasing user to retrieve the order in lieu of the purchaser via his/her own smartphone. Thus, the order can be transferred to another user, and the system may generate a new code and may optionally cancel the former code once the order is retrieved so that orders having one payment cannot be picked up twice. Once the order is picked up, the other users associated with the order can be notified.

Upon arriving at the venue, the user proceeds to a designated area whereby he/she presents the QR code/order identifier to the scanner/reader. Once the QR code is scanned and recognized as in Op. C1 of FIG. 5, the concessionaire shall retrieve the applicable tray with a matching order number from the assigned shelf, as described herein, and give it to the user to finalize the process. Alternatively, if a locker system issued, scanning the QR code or using another identifier such as Near Field Communication will cause the locker or kiosk containing the food to be opened whereby the user may retrieve the concession items ordered. The locker may be similar to the one described in U.S. Pat. No. 6,879,243, the content of which is incorporated herein by reference. The software described herein is configured to unlock the locker via an actuator or other lock device to enable self service pickup of orders.

In another implementation, the user may, under “My Orders” shown in FIG. 7, select the notification button to “I'm Here” to inform the venue that he/she has arrived and is proceeding toward the designated area for pickup. This shall enable that user's order to climb the fulfillment hierarchy as shown in FIG. 17 to minimize or remove any possible wait-time when his/her QR code is scanned.

In another implementation, the user may “share” his/her order with another user, which shall enable either user to retrieve the order. This process can occur automatically based on the user's profile or an optional functionality that arises once the order is confirmed. Following such a “sharing”, the non-purchasing user(s) will similarly find the order located under “My Orders” in FIG. 7 and, depending on that user's preference, have an email sent to his/her address. Upon the pickup, the QR code may become invalid to avoid a redundancy. In another implementation, if the recipient of the shared order does not have the application, that person will instead receive an email, sms, text or other means of notification, which will provide a unique QR code or other order identifier such that said person can retrieve the order in lieu of the original user. Such notification may also include the order details including the scheduled pickup time, the items in the order and information relating to the venue and movie/event.

As shown in FIG. 5, Op. A1 depicts the process whereby the venue's administrator may alter the product offerings/menu, promotions, specials and pricing on the administrator's unique, protected, internal internet page shown in FIG. 5a. Op. A2 then reveals how those inputs from FIG. 5a are transmitted to the user's product, whether said user is operating via the mobile application or website.

Once the user finalizes the order, the information is transmitted from the user's account as shown in Op. B1 of FIG. 5 to the servers where the data is concurrently redirected to the computers at the venue and the database, depicted in Op. B2 and Op. B3, respectively.

After the user has completed the ordering process, the order appears on the venue's system akin to FIG. 5b, based on the hierarchical structure provided in FIG. 17. When an order needs to be fulfilled based on the pickup time or other triggers (as provided below), that item may turn green to alert the concessionaire that the tray needs to be assembled given a specific amount of time prior to the scheduled pickup of the order. This time can either be fixed or variable depending on the assigned times allotted to each item in the order aggregated for a total estimated preparation/assembly or “prep” time. Those that are in the queue, but do not yet require action may remain in yellow. This serves to alert the concessionaires of upcoming orders to ensure operational efficiency. The colors discussed herein are not limiting and other visual aids, audible aids, tactile aids and combinations thereof can be used to alert the individual who assembles the order.

The hierarchical structure in FIG. 17 prioritizes the fulfillment of orders based on a list of criteria to minimize both the wait-time for the user and the amount of time that a completed tray sits idle and unclaimed. The system assigns greatest priority—and, as such, the next item to be fulfilled (i.e. what would be Order Number 001 in FIG. 5b)—to the user having his/her QR code scanned, if such order has not yet been assembled. This is designed to minimize any crowding at the designated pickup lane and to ensure rapid delivery.

Next in order fulfillment per FIG. 17 would be the user that has pressed the notification button “I'm Here” provided within an individual order located in “My Orders” in FIG. 7, to alert the system that the user has arrived at the venue and is en route to retrieving his/her order. In another implementation, for those venues offering such services, this option may also be used for direct delivery of one's order to a specific seat in the venue, which delivery may be offered for an extra fee.

The next several inputs into the hierarchical structure are specific to theaters or those venues where orders were intended to be retrieved at the time of the user's arrival to the venue. Per FIG. 17, that next input for prioritizing order fulfillment would be the user who has had his/her ticket scanned at the entrance of the venue. Following immediately behind would be the user who has used the onsite kiosks to print his/her tickets. Finally, for arrival-based fulfillment, the last item to be used in the hierarchy would be the use of geographic-based location services whereby a user has “checked-in” or similarly been recognized as having reached the venue. To avoid any possible confusion, these functionalities will only be considered in the hierarchy if they are triggered within a predetermined timeframe of the previously selected pickup time, which timeframe shall be established in conjunction with the user's profile and the venue itself. So, for instance, a moviegoer who picks up his/her tickets several hours before showtime will not have his/her order fulfilled based on that arrival without further corroboration. Should the user trigger one of these hierarchical items outside of that timeframe, a notification will be sent to the user's account asking if he/she wants to (a) pickup the order now, (b) keep the original time or (c) change the pickup time.

The final consideration in the structure, as shown in FIG. 17, is the pre-selected time for pickup that the user chose during the ordering process. Of course, this last option only occurs if none of the aforementioned triggers that cause the order to move up the fulfillment chain occur.

When an order requires assembly based on the aforementioned hierarchy of FIG. 17, that order may appear in green atop the queue, as shown in FIG. 5b. To fulfill that order, the concessionaire may touch the top order on the screen, which will cause it to expand and reveal the order's contents (compare Order Number 001 to 008 in FIG. 5b). Then, by pressing the “Fulfill” button, a receipt with the order may print and the applicable order may be deleted from the screen, causing all following orders to move up the queue. The concessionaire may then use that receipt to place the appropriate orders in a tray to await retrieval by the user. In a similar implementation, by pressing the “Fulfill” button, the applicable order may appear blue and remain at the top of the queue. Then, in that instance, when order has been fully assembled, the concessionaire may either swipe the order off the screen, moving that order into the order history, or tap on the order causing it to expand and revealing a “Done” button, which similarly moves the order into the order history.

In some embodiments, the user is sent a notification a set time before the order is fulfilled, alerting the user of a last opportunity to change the order. For example, if the pickup time is 7 pm and the preparation and buffer times amount to 5 minutes, the system may alert the user 10 minutes before the order is moved to the top of the order queue/ranking for fulfillment. The user would then be able to change their order until the 6:55 pm in this example. Once the employee selects the “Fulfill” button shown herein, the user's payment is processed.

Upon assembling the tray, the receipt will assign a shelf/locker number for the tray to be stored in prior to pickup by the user. While this system will vary from venue-to-venue, a rack of numbered shelves may be provided to the venue and the system will generate an assigned shelf number based on availability. It is also contemplated that self service lockers/kiosks can be used. When the user arrives and has his/her QR code scanned, or uses another order identifier as described herein, the concessionaire will be directed to the applicable assigned shelf number to quickly locate and present the correct order tray to the user. Simultaneously, the system will know that the applicable shelf number will no longer be utilized, enabling that shelf to be reassigned to the next order to be fulfilled.

In a similar implementation, rather than a numbered shelving system, the system may be integrated with a lighting system of small or large lights that are temporarily affixed to the trays during assembling. When the employee hits the “Fulfill” button in the two-touch system shown in FIG. 5b, the system may automatically link that particular order number to a specific light-enabled object, which will shut off either by pressing said light source or automatically after a certain amount of time. Then, when the user's QR code is scanned, it may cause the light-enabled object to again blink to guide the concessionaire toward retrieving the appropriate tray for fulfillment.

In a similar implementation, when a particular order turns green (prompting fulfillment), instead of expanding the order to show the individual items prior to pressing “Fulfill” (i.e. the “Two-Button System”), the employee may opt for a “One-Button System”, whereby simply swiping or touching the order—or a “Fulfill” button enclosed in the order bar—will cause a receipt to print and a light to blink as mentioned above.

In order for the concessionaire to search or review prior orders, the concessionaire may alter between screens, as shown atop FIG. 5b, from “Pending” to “Filled”. The “Pending” screen is what is currently displayed in FIG. 5b and reflects the hierarchical structure for upcoming order fulfilment. The “Filled” screen reveals orders that have already been fulfilled and may, at the venue's discretion, be limited to a specific timeframe before those orders are cached in the venue's archival history. These orders may be sorted by order number, time fulfilled, pickup time, or other similar metrics.

The software operating at the venue also may require a concessionaire sign-in as seen in the top right corner of FIG. 5b. If the venue chooses to assign a particular employee to a station, this enables the venue to monitor the employee's efficiency in fulfilling orders and comparing such efficiency to other employees based on a variety of related metrics.

In another implementation, to supplement the hierarchical structure shown in FIG. 17, the venue may assign preparation/assembly or “prep” times to each individual item on its menu. By assigning such times to each individual item, the system will be able to calculate how much total time it should take the concessionaire to assemble a particular order given its components. This calculation can also be used to determine the prioritization of fulfillment to ensure that orders that will take longer to assemble are queued for fulfillment with the proper time before pickup. Over time, based on an algorithmic structure, the system will develop more accurate fulfillment times for each item, which will then be applied to further items and, similarly, that data can be provided to the venues for their future operational needs. In addition, where different employees have different fulfillment speeds, employees who are faster would be assigned a higher percentage of orders.

Ultimately, all of the information regarding the user's account will be stored in a database as seen in Op. B3 and Op. C2 of FIG. 5, that may be used to, among other things, further customize the user's experience, enable direct marketing to that consumer by the merchant venues and maximize the operations of the venues themselves.

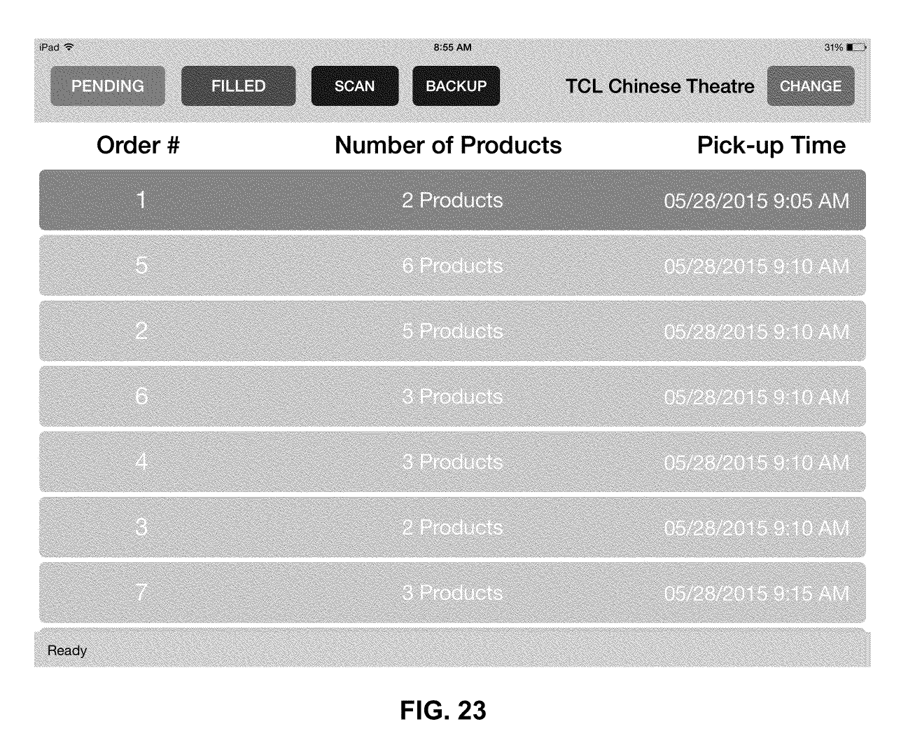

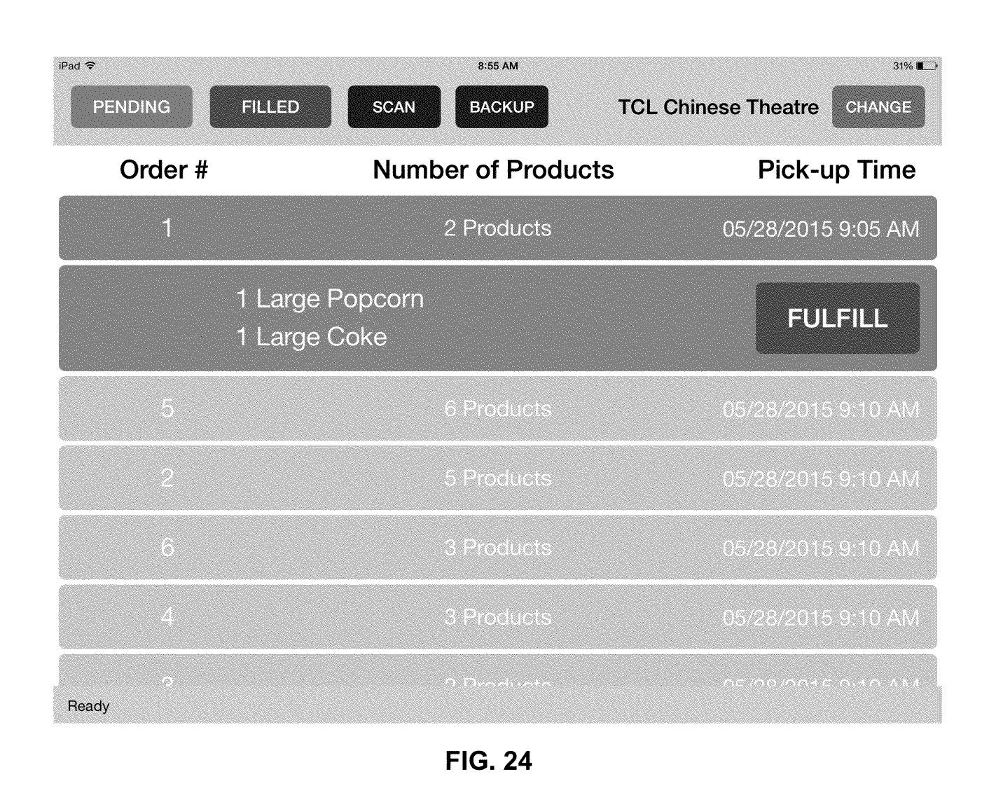

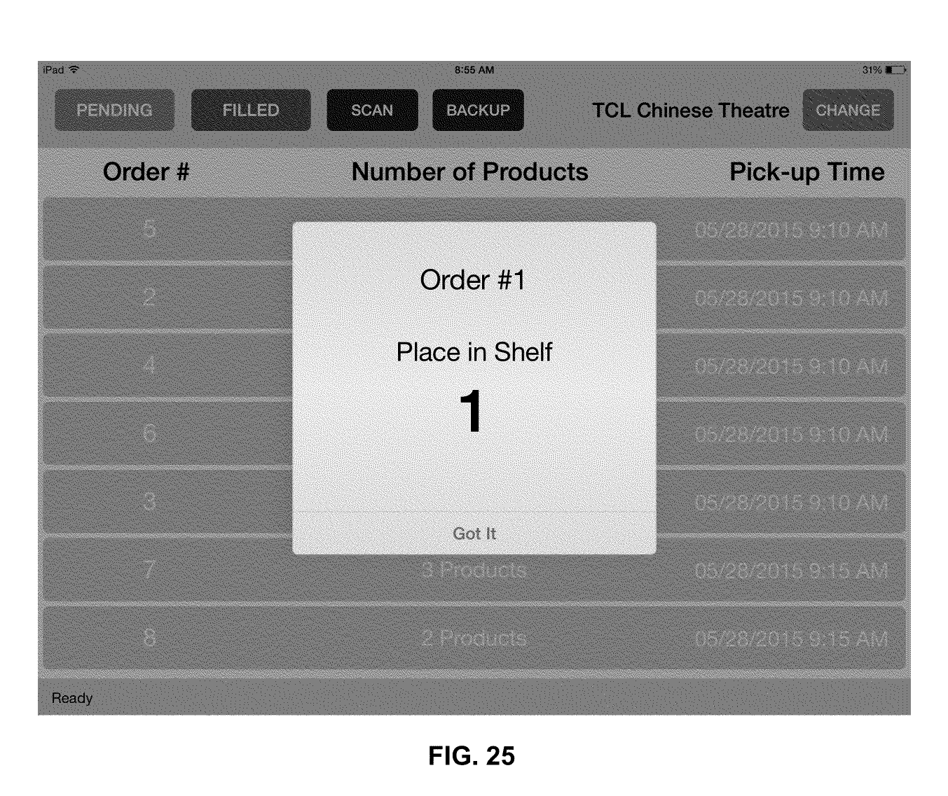

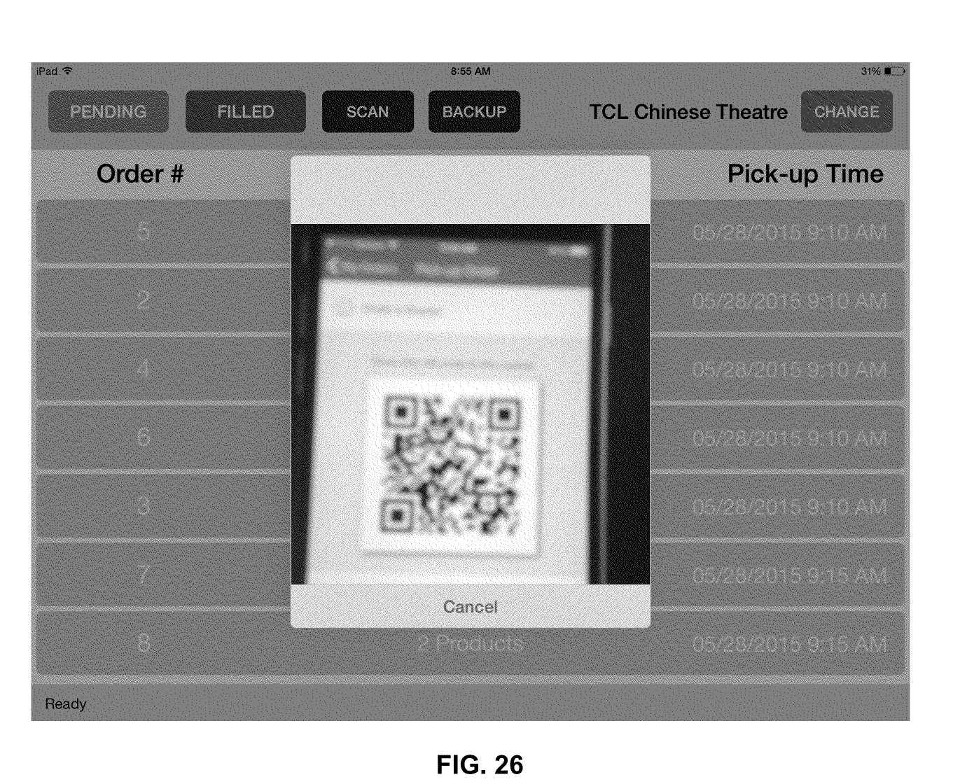

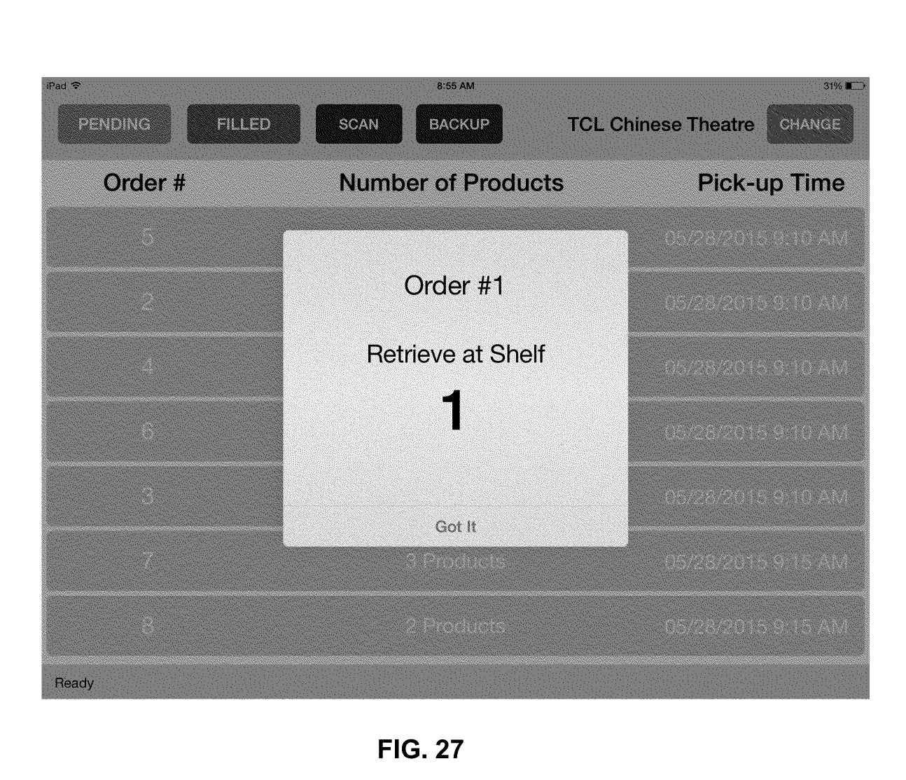

In FIG. 23, the order queue/ranking is shown, In FIG. 24, the employee can select “Fulfill” to begin assembling the order. In FIG. 25, the storage location for the order is assigned. In FIG. 26, the order identifier is read by the system. In FIG. 27, the storage location is displayed so that the proper order can be delivered to the user.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for delivery of pre-ordered concession items in a movie theater comprising:
a system computer in communication with a user computer via a network;
an order received by said system computer via said network and indicative of at least one concession item and a first time indicative of when a user submitting the order would like to pick up the order;
an order fulfillment device displaying data indicative of the order and determining a storage location for said order;
an order identification reader associated with said system computer and reading an order identification indicative of a request to retrieve said order;
a delivery device associated with said system computer and displaying data indicative of the storage location where said order is stored and receiving a selection indicating that the order has been delivered.

2. The system of claim 1 further comprising:
said order including a plurality of orders, each order associated with a second time indicative of a length of time allocated to preparation of the corresponding order;
said order fulfillment device generating a ranking of the plurality of orders based on the first time and the second time associated with each one of the plurality of orders.

3. The system of claim 2 further comprising:
a location module associated with said system computer and determining a location of the user associated with at least one of the plurality of orders;
said order fulfillment device adjusting the ranking based on an adjusted first time, the adjusted first time based on a distance between the movie theater and the location.

4. The system of claim 1 wherein said order identification is selected from the group consisting of: a QR code, a barcode, a text code or combinations thereof.

5. The system of claim 1 further comprising:
an order sharing module associated with said system computer and allowing the user to designate at least one second user who is authorized to pickup said order;
said order sharing module generating at least a second order identification for each of the at least one second user, each second order identification different and different from the order identification wherein said system computer reading the at least a second order identification is indicative of a request to retrieve said order.

6. The system of claim 1 wherein the reader reads the order identification through Near Field Communication, Bluetooth, or Wireless communication.

7. A system for delivering pre-ordered concession items comprising:
a system computer in communication with a user computer via a network and having software executing thereon;
said software receiving an order via said network and indicative of at least one concession item and a first time indicative of when a user submitting the order would like to pick up the order;
said software determining a storage location for said order and transmitting data for display to a fulfillment device, the data indicative of the order and the storage location;
said software receiving an order identification from a reader, the order identification indicative of a request to retrieve said order;
said software generating location data for display, the location data indicative of the storage location where said order is stored, said location data transmitted to: the storage location, a display, a printer or combinations thereof.

8. The system of claim 7 wherein the storage location is a shelf.

9. The system of claim 7 wherein the storage location is a locker and upon receiving the order identification, said software unlocks the locker such that the user can retrieve the order from the locker.

10. The system of claim 7 further comprising:
a fulfillment identification received by said software via said fulfillment device, the fulfillment identification indicative of said order being available for pickup in the storage location.

11. The system of claim 10 wherein the fulfillment identification includes a start identification and an end identification, the end identification indicative of the order available for pickup, the start identification indicative of the order is about to be assembled and wherein the user is notified of a final opportunity to make changes to the order upon selection of the start identification.

12. The system of claim 11 further comprising:
said order including a plurality of orders, each order associated with a second time indicative of a length of time allocated to preparation of the corresponding order;
said software generating a ranking of the plurality of orders based on the first time and the second time associated with each one of the plurality of orders.
wherein said second time is updated based on a difference in time between the start and end identifications for a plurality of orders.

13. The system of claim 12 wherein the second time includes a preparation time and a buffer time.

14. The system of claim 13 wherein said software adjusts the buffer time based on the number of orders due within a time range.

15. The system of claim 7 wherein the reader reads the order identification through Near Field Communication, Bluetooth, or Wireless communication.

16. A method of pre-order and delivery of movie theater concession items comprising:
providing a system computer having a software application executing thereon, the software application accessible by a user from a user device;
receiving an order from the user via said software application, the order indicative of at least one concession item and a first time, the first time associated with at least one movie show time;
calculating via said software application a second time associated with an amount of time allocated to preparation of said order;
displaying said order via a display device at a third time, the third time before the first time by an amount at least equal or greater than the second time;
associating said order with a storage location via said software application;
receiving an order identification associated with the order at said software application, said order identification indicative of a request to pick up said order;

[symbol]

17. The method of claim 16 further comprising:
displaying visual indication associated with the storage location at the display device, at a second display device or at the storage location.

18. The method of claim 16 further comprising:
adjusting the third time based on a location associated with the user device.

19. The method of claim 16 wherein said storage location is a locker and further comprising:
transmitting a request to open the locker via said software application after receiving the order identification.

20. The method of claim 19 wherein a first side of the locker is configured to receive the at least one concession item therein for placement in the locker and a second side of the locker is unlocked upon transmission of the request to open the locker.

21. The method of claim 16 further comprising:
generating at least a second order identification associated with said order upon receiving a request to share said order with at least a second user, wherein said receiving step includes receiving one of said order identification or said at least a second order identification such that the user or the at least a second user is able to request pickup of said order.
